(19) United States
(12) Patent Application Publication
(10) Pub. No.: US 2026/0317150 A1
(43) Pub. Date: Oct. 15, 2026

(54) AUTOMATED BEVERAGE POURING SYSTEM

(71) Applicant: WhidBrew Technologies, Inc, Langley, WA (US)

(72) Inventor: William Harr, Langley, WA (US)

(21) Appl. No.: 19/647,805

(22) Filed: Apr. 14, 2026

Related U.S. Application Data
(60) Provisional application No. 63/788,419, filed on Apr. 14, 2025.

(51) Int. Cl. B67D 1/08; B67D 1/00

(52) U.S. Cl. CPC B67D 1/0878; B67D 1/0081; B67D 1/0801; B67D 2210/00076; B67D 2210/00078

(57) ABSTRACT

An automated beverage dispensing system includes a conveyance system having a plurality of container receivers configured to move through a series of successive positions. A container dispenser selectively dispenses beverage containers of different sizes into the container receivers. A pouring assembly includes one or more pour bodies, each having a spigot with a control valve fluidly coupled to a beverage source. Each pour body is vertically movable to lower the spigot into and raise the spigot within a beverage container during a pour. A control system receives beverage orders, directs the container dispenser, the conveyance system, and the pouring assembly to fill beverage containers according to pouring procedures selected from a database based on factors such as beverage type, temperature, and customer preferences. The pouring procedures define spigot depth profiles, valve opening profiles, and multi-phase pours including body-fill and head-generation phases to control foam generation.

### BACKGROUND

Dispensing beverages in a busy establishment can be time-consuming and create delays in serving customers in such establishments. This can be especially true with beer, as techniques for pouring beer so as to optimally control generation of head can require relatively slow pour speeds, can require specific training and experience, and can even vary from product to product.

Automated beverage pouring and dispensing systems can be used to save time and free employees to attend to other tasks. However, such machines face challenges and roadblocks in achieving true efficiency, and also in avoiding problems such as load management, cross-contamination of differing beverages, dealing with different sizes of beverage containers, tracking and identifying poured beverages, and the like.

### BRIEF DESCRIPTION OF THE DRAWINGS

FIG. 1 is a perspective view of an embodiment of an automated beverage dispensing system including a carousel, a container dispenser, and a pouring assembly, in accordance with some embodiments.

FIG. 2 is a top plan view of the automated beverage dispensing system of FIG. 1, in accordance with some embodiments.

FIG. 3 is a flowchart illustrating an embodiment of a method of operating an automated beverage dispensing system, in accordance with some embodiments.

FIG. 4 is a top plan view of an automated beverage dispensing system including a track, a container dispenser, and a pouring assembly, in accordance with some embodiments.

FIG. 5 is a side elevation view of an automated beverage dispensing system including a conveyor, a pouring assembly, and a plurality of electronic displays, in accordance with some embodiments.

FIG. 6 is a schematic block diagram of a control system for an automated beverage dispensing system, in accordance with some embodiments.

FIG. 7 is a side view of an embodiment of a pouring assembly illustrating a pour body mounted in a body track, showing the pour body in a pouring position in which a spigot is aligned with a container receiver and in a displaced position in which the spigot is out of alignment with the container receiver.

FIG. 8 is a top plan view of another embodiment of the automated beverage dispensing system including a linear conveyor, a container dispenser having a plurality of hoppers, a pouring assembly having a first pour body and a second pour body, and a label printer.

### SUMMARY

An automated beverage dispensing system includes a carousel configured to rotate about an axis. The carousel includes a plurality of container receivers, each of which is configured to hold a beverage container. A container dispenser is positioned adjacent the carousel and is configured to selectively dispense a beverage container into an aligned one of the container receivers. A pouring assembly includes a pour body having a spigot that includes a control valve. The pour body is configured to move vertically so as to selectively lower the spigot into the beverage container and raise the spigot out of the beverage container. The spigot is configured to be fluidly connected to a beverage source. A control system is operatively connected to the carousel, the container dispenser, and the pouring assembly. The control system is configured to receive a beverage order from a user, direct the container dispenser to dispense a beverage container into an aligned container receiver, rotate the carousel to move the beverage container into alignment with the spigot, direct the pour body to lower the spigot into the beverage container, direct the control valve of the spigot to dispense a volume of beverage from the beverage source into the beverage container resulting in a filled beverage container, and rotate the carousel to move the filled beverage container to an access zone for retrieval.

In some embodiments, the container dispenser includes a plurality of hoppers, each of which is configured to hold a different size of beverage container. The control system can be configured to determine a size of the beverage container dispensed into the aligned container receiver, compare the determined size to an expected size corresponding to the beverage order, and direct the spigot to dispense a volume of beverage corresponding to the determined size.

In some embodiments, the pouring assembly includes a plurality of pour bodies, each having a spigot. The spigots can be fluidly connected to different beverage sources. The spigots of the plurality of pour bodies can have different flow characteristics.

In some embodiments, a labeling system is configured to apply a label to the filled beverage container. The label includes information related to the beverage order. In some embodiments, a plurality of displays are each associated with one of the container receivers in the access zone and are configured to display information related to the beverage order.

In some embodiments, the control system is configured to access a database of pouring procedures, select a pouring procedure based on the beverage order, and direct the spigot to fill the beverage container according to the selected pouring procedure. The control system can be configured to select the pouring procedure based on at least one of a beverage type, a beverage temperature, an ambient temperature, a barometric pressure, a carbonation level of the beverage, a customer preference, and/or a spigot type.

In some embodiments, the pouring procedure includes a body-fill phase in which the control valve is opened to a first degree and the spigot is positioned at or near a bottom of the beverage container, and a head-generation phase in which the control valve is adjusted to a second degree different from the first degree and/or the spigot is raised to a position at or above a liquid surface within the beverage container so as to generate a foam head on the beverage.

In some embodiments, the pouring procedure defines a spigot withdrawal profile specifying a vertical position of the spigot relative to the beverage container as a function of time and/or as a function of a volume of beverage dispensed. The control system can be configured to direct the pour body to move the spigot in accordance with the spigot withdrawal profile during the pour.

In some embodiments, the control valve is a proportional valve and the pouring procedure defines a valve opening profile specifying a degree of opening of the proportional valve over the course of the pour. The control system can be configured to adjust the proportional valve during the pour in accordance with the valve opening profile.

In some embodiments, a fill-level sensor is configured to detect a liquid level within the beverage container during the pour. The control system can be configured to receive data from the fill-level sensor during the pour and adjust one or more parameters of the pouring procedure in real time based on the detected liquid level.

In some embodiments, a flow sensor is disposed in a flexible line between the beverage source and the spigot. The flow sensor is configured to measure a volume of beverage flowing through the flexible line. The control system can be configured to close the control valve when the measured volume reaches a target pour volume.

In some embodiments, the pour body is configured to move the spigot out of alignment with the container receiver after filling the beverage container so as to avoid drips into a subsequently aligned container receiver.

In some embodiments, the control system is configured to receive the beverage order from a remote interface on a personal computing device of a customer. The beverage order can include a customer location within a venue. The control system can be configured to direct a labeling system and/or an electronic display to associate the customer location with the filled beverage container.

In some embodiments, the control system is configured to record a volume of beverage dispensed for each pour, calculate an estimated remaining volume of beverage in the beverage source, and generate an alert when the estimated remaining volume falls below a threshold.

An automated beverage dispensing system includes a conveyance system that includes a plurality of container receivers. The conveyance system is configured to move the container receivers through a series of successive positions. A container dispenser is configured to selectively dispense a container into an aligned one of the plurality of container receivers. A pouring assembly includes a pouring body having a spigot. The pouring body is movable so that the spigot can be lowered into a container held in an aligned one of the container receivers. The spigot has a valve and is configured to be operatively connected to a source of beverage. A control system is configured to receive an order request and direct operation of the conveyance system, the container dispenser, and the pouring assembly so as to fill a container with a beverage from the source of beverage, including directing the pouring body to raise the spigot within the container during dispensing of the beverage, and deliver the container to an access zone.

In some embodiments, the control system is configured to access a database of pouring procedures, select a pouring procedure based on an identity of the beverage, and direct the pouring body to execute the selected pouring procedure. The selected pouring procedure includes directing the pouring body to raise the spigot within the container during dispensing of the beverage so as to control foam generation within the container.

In some embodiments, the conveyance system includes a linear conveyor configured to move the plurality of container receivers in a single direction along a substantially straight path from a first end of the linear conveyor adjacent the container dispenser to a second end of the linear conveyor at the access zone.

An automated beverage dispensing system includes a pouring assembly having a pour body with a spigot, the spigot including a control valve and being fluidly coupled to a beverage source via a flexible line. The pour body is configured to move vertically so as to lower the spigot into a beverage container and raise the spigot within the beverage container during a pour. A control system is operatively connected to the pouring assembly. The control system includes a database storing a plurality of pouring procedures, each pouring procedure defining a plurality of pour parameters for a corresponding beverage. The control system is configured to receive a beverage order identifying a beverage, select a pouring procedure from the database based on the identified beverage, and direct the pouring assembly to fill the beverage container with the beverage according to the selected pouring procedure.

In some embodiments, each pouring procedure defines a body-fill phase and a head-generation phase. During the body-fill phase, the spigot is positioned at or near a bottom of the beverage container and the control valve is opened to a first degree so as to deliver the beverage at a first flow rate. During the head-generation phase, the spigot is raised to a position at or above a liquid surface within the beverage container and/or the control valve is adjusted to a second degree different from the first degree so as to generate a foam head on the beverage.

In some embodiments, the pouring procedure further defines a transition phase between the body-fill phase and the head-generation phase. The transition phase includes a pause interval during which the control valve is closed and/or restricted so as to allow foam within the beverage container to at least partially settle before the head-generation phase begins.

In some embodiments, each pouring procedure defines a spigot withdrawal profile specifying a vertical position of the spigot relative to the beverage container as a function of time and/or as a function of a volume of beverage dispensed. The control system is configured to direct the pour body to move the spigot in accordance with the spigot withdrawal profile during the pour.

In some embodiments, the control valve is a proportional valve, and each pouring procedure defines a valve opening profile specifying a degree of opening of the proportional valve over the course of the pour. The control system is configured to continuously and/or periodically adjust the proportional valve during the pour in accordance with the valve opening profile.

In some embodiments, the database stores a plurality of pouring procedures for the same beverage, each corresponding to a different set of conditions. The control system is configured to select the pouring procedure based on a combination of factors including at least two of: an identity of the beverage, a size of the beverage container, a spigot type of the pour body, a detected temperature of the beverage, a detected ambient temperature, a detected barometric pressure, an elevation value, and/or a customer preference.

In some embodiments, the control system is configured to interpolate between two or more stored pouring procedures to generate a modified pouring procedure tailored to a detected combination of conditions.

In some embodiments, the database is configured to be updated remotely via a network connection. A beverage producer can transmit updated pouring procedures to the control system, and the control system can store the updated pouring procedures in the database.

In some embodiments, one or more sensors are configured to monitor characteristics of the beverage during the pour. The control system is configured to receive sensor data during the pour, compare the sensor data to an expected value defined by the selected pouring procedure, and adjust one or more pour parameters in real time in response to the sensor data deviating from the expected value by more than a threshold amount.

In some embodiments, a foam sensor is configured to detect a foam height on the beverage within the beverage container during and/or after the pour. The control system is configured to adjust the pouring procedure based on the detected foam height.

In some embodiments, the control system is configured to log pour parameters and sensor data for each pour and to update the pouring procedures stored in the database based on analysis of the logged data.

An automated beverage dispensing system includes a conveyance system having a plurality of container receivers configured to move through a series of successive positions. A pouring assembly includes a first pour body having a first spigot fluidly coupled to a first beverage source and a second pour body having a second spigot fluidly coupled to a second beverage source. Each pour body is configured to move vertically so as to lower the corresponding spigot into a beverage container held in an aligned one of the container receivers. A control system is operatively connected to the conveyance system and the pouring assembly. The first pour body and the second pour body are spaced apart along the conveyance system so that the first spigot and the second spigot are each simultaneously alignable with a different one of the container receivers. The control system is configured to direct the first pour body and the second pour body to simultaneously pour different beverages into different beverage containers in different container receivers.

In some embodiments, the first spigot includes a sparkler attachment and the second spigot does not include a sparkler attachment, such that the first spigot and the second spigot have different flow characteristics.

In some embodiments, more than one beverage source is fluidly coupled to at least one of the spigots, and a valve mechanism is configured to selectively connect one of the beverage sources to the spigot so as to enable the pour body to pour more than one beverage.

In some embodiments, the control system is configured to sequence orders so that a beverage container for the first beverage is dispensed into the container receiver that will align with the first pour body, and a beverage container for the second beverage is dispensed into the container receiver that will align with the second pour body, so as to maximize simultaneous utilization of the first pour body and the second pour body.

An automated beverage dispensing system includes a conveyance system having a plurality of container receivers configured to move through a series of successive positions. A pouring assembly includes at least a first pour body having a first spigot fluidly coupled to a first beverage source and a second pour body having a second spigot fluidly coupled to a second beverage source different from the first beverage source. Each pour body is configured to move vertically so as to selectively lower and raise the corresponding spigot relative to a beverage container held in an aligned one of the container receivers. Each pour body is further configured to move the corresponding spigot out of alignment with the aligned container receiver after filling the beverage container so as to prevent residual liquid from the spigot from dripping into a subsequently aligned beverage container that has been filled with a different beverage by a different pour body.

In some embodiments, each pour body is movably supported by a body track coupled to a pour base. The body track defines a first portion that is substantially vertical and a second portion that deviates from vertical so as to direct the pour body away from alignment with the container receiver when the pour body is moved along the second portion of the body track.

In some embodiments, the body track defines a J-shaped profile, an L-shaped profile, and/or a cam-shaped profile when viewed from a side of the pour base.

In some embodiments, the second portion of the body track includes a detent, a latch, and/or a friction feature configured to retain the pour body in a displaced position until the pour body is actively driven back toward a pouring position.

In some embodiments, a first motor is configured to move the pour body vertically and a second motor is configured to move the pour body horizontally, and a control system is configured to independently control the first motor and the second motor so as to displace the spigot out of alignment with the container receiver after filling the beverage container.

In some embodiments, a drip tray is positioned beneath a displaced position of the spigot to collect residual liquid dripping from the spigot when the spigot is out of alignment with the container receiver.

In some embodiments, a rinse mechanism is configured to direct a cleaning fluid over and/or through the spigot when the spigot is in the displaced position.

An automated beverage dispensing system includes a conveyance system having a plurality of container receivers configured to move through a series of successive positions. A container dispenser is configured to selectively dispense beverage containers of different sizes into aligned ones of the container receivers. The container dispenser includes a plurality of hoppers, each hopper configured to hold a stack of beverage containers of a particular size. A control system is operatively connected to the conveyance system and the container dispenser. The control system is configured to receive a beverage order specifying a beverage and a container size, direct the container dispenser to dispense a beverage container of the specified container size into an aligned container receiver, detect a size of the dispensed beverage container using one or more sensors, compare the detected size to the specified container size, and proceed with filling the beverage container in response to the detected size matching the specified container size.

In some embodiments, the control system is configured to initiate an error-handling action in response to the detected size not matching the specified container size. The error-handling action includes at least one of generating an alarm, halting advancement of the conveyance system, advancing the container receiver past a pouring position without performing a pour, and/or re-queuing the beverage order for fulfillment with a correct container size.

In some embodiments, the container dispenser includes a rotating mount supporting the plurality of hoppers. The rotating mount is configured to rotate so as to align a selected one of the hoppers with the aligned container receiver.

In some embodiments, each container receiver has a tapered interior profile and/or one or more stepped portions configured to receive and support a plurality of different sizes of beverage containers at different depths within the container receiver without requiring adjustment of the container receiver.

In some embodiments, one or more hopper sensors are configured to detect a quantity of beverage containers remaining within each hopper. The control system is configured to generate an alert when the quantity falls below a threshold and/or to predict when a hopper will become empty based on a current rate of container dispensing.

An automated beverage dispensing system includes a conveyance system having a plurality of container receivers configured to move through a series of successive positions. A pouring assembly is configured to fill beverage containers held in the container receivers with a beverage from a beverage source. A control system is operatively connected to the conveyance system and the pouring assembly. The control system is configured to receive a beverage order from a remote interface on a personal computing device of a customer, the beverage order including an identity of a beverage, a container size, and a customer location within a venue. The control system is configured to direct the conveyance system and the pouring assembly to fill a beverage container with the beverage. The control system is configured to associate the customer location with the filled beverage container so that the filled beverage container can be delivered to the customer at the customer location.

In some embodiments, the remote interface is a software application executable on the personal computing device. The remote interface presents a menu of available beverages dynamically generated by the control system based on beverages currently connected to the pouring assembly.

In some embodiments, the remote interface is accessed by the customer scanning a machine-readable code displayed at the customer location within the venue. The machine-readable code encodes information identifying the venue, the automated beverage dispensing system, and/or the customer location.

In some embodiments, the control system is configured to transmit order status updates to the remote interface as the beverage order progresses through the automated beverage dispensing system. The order status updates include at least one of an order confirmation, an estimated fulfillment time, a pouring-in-progress notification, and/or a ready-for-pickup notification.

In some embodiments, the control system is configured to receive a requested fulfillment time as part of the beverage order, calculate a target pour start time based on the requested fulfillment time and an estimated fulfillment duration, and initiate fulfillment of the beverage order at the target pour start time.

In some embodiments, the remote interface is configured to enable the customer to establish a tab. The customer can place multiple beverage orders over time against the tab. The control system is configured to maintain tab data and enforce configurable limits on the tab.

In some embodiments, the control system is configured to enforce age verification requirements by prompting the customer to provide proof of age via the remote interface and rejecting the beverage order if the customer's age does not meet a minimum age threshold.

An automated beverage dispensing system includes a conveyance system having a plurality of container receivers configured to move through a series of successive positions. A pouring assembly includes a pour body having a spigot fluidly coupled to a beverage source. A fill-level sensor is configured to detect a liquid level and/or a foam level within a beverage container during a pour. A control system is operatively connected to the conveyance system, the pouring assembly, and the fill-level sensor. The control system is configured to direct the pour body to fill the beverage container with a beverage according to a pouring procedure, receive sensor data from the fill-level sensor during the pour, compare the sensor data to an expected value defined by the pouring procedure, and adjust one or more pour parameters in real time in response to the sensor data deviating from the expected value.

In some embodiments, the one or more pour parameters adjusted in real time include at least one of a valve opening degree, a spigot withdrawal rate, and/or a pour duration.

In some embodiments, a foam sensor is configured to detect a foam height on the beverage within the beverage container. The control system is configured to extend and/or shorten a head-generation phase of the pouring procedure based on the detected foam height.

In some embodiments, the control system is configured to log the pour parameters and the sensor data for each pour and to update pouring procedures stored in a database based on analysis of the logged data using a machine learning algorithm.

In some embodiments, a flow sensor is disposed in a flexible line between the beverage source and the spigot. The flow sensor is configured to measure a volume of beverage flowing through the flexible line. The control system is configured to close a control valve of the spigot when the measured volume reaches a target pour volume defined by the pouring procedure.

A method of automatically dispensing a beverage includes receiving, by a control system, a beverage order from a user, the beverage order identifying a beverage and a container size. The method includes directing, by the control system, a container dispenser to dispense a beverage container of the identified container size into a container receiver of a conveyance system. The method includes advancing, by the control system, the conveyance system to move the container receiver into alignment with a spigot of a pouring assembly. The method includes directing, by the control system, a pour body of the pouring assembly to lower the spigot into the beverage container. The method includes directing, by the control system, a control valve of the spigot to open so as to dispense the beverage from a beverage source into the beverage container. The method includes directing, by the control system, the pour body to raise the spigot within the beverage container during dispensing of the beverage. The method includes advancing, by the control system, the conveyance system to move the filled beverage container to an access zone for retrieval.

In some embodiments, the method further includes detecting, by one or more sensors, a size of the dispensed beverage container, and comparing, by the control system, the detected size to an expected size corresponding to the beverage order. The method includes proceeding with dispensing the beverage in response to the detected size matching the expected size, and/or initiating an error-handling action in response to the detected size not matching the expected size.

In some embodiments, the method further includes applying, by a labeling system, a label to the filled beverage container, the label including information related to the beverage order.

In some embodiments, the method further includes displaying, by an electronic display associated with the container receiver in the access zone, information related to the beverage order, and ceasing display of the information in response to a sensor detecting removal of the filled beverage container from the container receiver.

In some embodiments, the method further includes, after dispensing the beverage, directing, by the control system, the pour body to move the spigot out of alignment with the container receiver so as to prevent residual liquid from dripping into a subsequently aligned beverage container.

In some embodiments, the method further includes recording, by the control system, a volume of beverage dispensed, calculating an estimated remaining volume of beverage in the beverage source, and generating an alert when the estimated remaining volume falls below a threshold.

A method of pouring a beverage using an automated beverage dispensing system includes receiving, by a control system, a beverage order identifying a beverage. The method includes accessing, by the control system, a database storing a plurality of pouring procedures, each pouring procedure defining a plurality of pour parameters for a corresponding beverage. The method includes selecting, by the control system, a pouring procedure from the database based on the identified beverage. The method includes directing, by the control system, a pour body to lower a spigot into a beverage container and execute the selected pouring procedure, the pouring procedure including a body-fill phase in which the spigot is positioned at or near a bottom of the beverage container and a control valve is opened to a first degree, and a head-generation phase in which the spigot is raised to a position at or above a liquid surface within the beverage container and/or the control valve is adjusted to a second degree different from the first degree so as to generate a foam head on the beverage.

In some embodiments, the method further includes selecting the pouring procedure based on a combination of factors including at least two of: an identity of the beverage, a size of the beverage container, a spigot type, a detected temperature of the beverage, a detected ambient temperature, a detected barometric pressure, an elevation value, and/or a customer preference.

In some embodiments, the pouring procedure further defines a transition phase between the body-fill phase and the head-generation phase. The transition phase includes a pause interval during which the control valve is closed and/or restricted so as to allow foam within the beverage container to at least partially settle before the head-generation phase begins.

In some embodiments, the pouring procedure defines a spigot withdrawal profile specifying a vertical position of the spigot relative to the beverage container as a function of time and/or as a function of a volume of beverage dispensed. The method includes directing the pour body to move the spigot in accordance with the spigot withdrawal profile during the pour.

In some embodiments, the pouring procedure defines a valve opening profile specifying a degree of opening of a proportional valve over the course of the pour. The method includes adjusting the proportional valve during the pour in accordance with the valve opening profile.

In some embodiments, the method further includes receiving sensor data from a fill-level sensor and/or a foam sensor during the pour, comparing the sensor data to an expected value defined by the selected pouring procedure, and adjusting one or more pour parameters in real time in response to the sensor data deviating from the expected value.

In some embodiments, the method further includes logging the pour parameters and sensor data for each pour and updating the pouring procedures stored in the database based on analysis of the logged data.

A method of preventing cross-contamination in an automated beverage dispensing system includes filling, by a first pour body having a first spigot, a first beverage container with a first beverage from a first beverage source. The method includes, after filling the first beverage container, displacing the first spigot out of alignment with the container receiver holding the first beverage container. The method includes advancing a conveyance system so that a second beverage container that has been filled with a second beverage by a second pour body moves into a position beneath the first pour body. The displacing of the first spigot out of alignment with the container receiver prevents residual liquid of the first beverage from dripping from the first spigot into the second beverage container, thereby preventing cross-contamination of the second beverage with the first beverage.

In some embodiments, the displacing includes moving the first pour body along a body track that defines a first portion that is substantially vertical and a second portion that deviates from vertical so as to direct the first spigot away from alignment with the container receiver.

In some embodiments, the displacing includes actuating a first motor to raise the first pour body vertically and actuating a second motor to translate the first pour body horizontally.

In some embodiments, the method further includes collecting, by a drip tray positioned beneath a displaced position of the first spigot, residual liquid dripping from the first spigot.

In some embodiments, the method further includes directing, by a rinse mechanism, a cleaning fluid over and/or through the first spigot when the first spigot is in the displaced position.

A method of managing orders in an automated beverage dispensing system includes receiving, by a control system, a plurality of beverage orders. The method includes maintaining, by the control system, an order queue storing the plurality of beverage orders. The method includes implementing, by the control system, a prioritization algorithm that sequences the beverage orders in the order queue based on at least one of a beverage identity, a container size, a requested fulfillment time, and/or an availability of pour bodies of a pouring assembly. The method includes directing, by the control system, operation of a conveyance system, a container dispenser, and the pouring assembly to fulfill the beverage orders in the sequenced order.

In some embodiments, the prioritization algorithm interleaves orders for different beverages so as to maximize simultaneous utilization of a plurality of pour bodies, each pour body being fluidly coupled to a different beverage source.

In some embodiments, the prioritization algorithm batches orders for the same beverage and the same container size so as to reduce rotation of a container dispenser between consecutive dispensing operations.

In some embodiments, the method further includes maintaining, by the control system, a data structure associating each container receiver with a current state selected from an empty state, a dispensing state, a verification state, a pouring state, a labeling state, an access state, and/or an alarm state. The method includes transitioning each container receiver from one state to the next as the conveyance system advances and operations are performed.

In some embodiments, the method further includes calculating, by the control system, an estimated fulfillment time for each beverage order and communicating the estimated fulfillment time to a user interface and/or to a remote interface on a personal computing device of a customer.

In some embodiments, the method further includes detecting, by the control system, an error condition selected from a container size mismatch, a container dispensing failure, a pour failure, a conveyance jam, a hopper depletion, a source depletion, a labeling failure, and/or a container overflow, and executing a corresponding error-handling routine.

A method of remotely ordering a beverage from an automated beverage dispensing system includes accessing, by a customer via a personal computing device, a remote interface of the automated beverage dispensing system. The method includes displaying, on the remote interface, a menu of available beverages dynamically generated based on beverages currently connected to a pouring assembly of the automated beverage dispensing system. The method includes receiving, via the remote interface, a beverage order from the customer, the beverage order including an identity of a beverage, a container size, and a customer location within a venue. The method includes transmitting the beverage order to a control system of the automated beverage dispensing system. The method includes directing, by the control system, the automated beverage dispensing system to fill a beverage container with the beverage. The method includes associating the customer location with the filled beverage container so that the filled beverage container can be delivered to the customer at the customer location.

In some embodiments, the method further includes transmitting, by the control system, order status updates to the remote interface as the beverage order progresses through the automated beverage dispensing system.

In some embodiments, the method further includes receiving, via the remote interface, a requested fulfillment time, calculating a target pour start time, and initiating fulfillment of the beverage order at the target pour start time so that the filled beverage container arrives at an access zone at approximately the requested fulfillment time.

In some embodiments, the method further includes accessing the remote interface by scanning a machine-readable code displayed at the customer location. The machine-readable code encodes information identifying the venue and/or the customer location.

In some embodiments, the method further includes enforcing, by the control system, age verification requirements by prompting the customer to provide proof of age via the remote interface.

A method of cleaning an automated beverage dispensing system includes disconnecting, by a cleaning-in-place system, a beverage source from a flexible line fluidly coupled to a spigot of a pouring assembly. The method includes connecting the flexible line to a reservoir of cleaning solution. The method includes directing, by a control system, the cleaning-in-place system to circulate the cleaning solution through the flexible line and the spigot for a defined duration. The method includes directing, by the control system, a rinse cycle with water through the flexible line and the spigot to flush the cleaning solution. The method includes locking out, by the control system, the pouring assembly from dispensing beverages during the cleaning cycle and the rinse cycle.

In some embodiments, the control system directs the cleaning-in-place system to perform the cleaning cycle at scheduled intervals.

In some embodiments, the control system directs the cleaning-in-place system to perform the cleaning cycle in response to a change of the beverage source.

An automated beverage dispensing system includes a conveyance system having a plurality of container receivers configured to move through a series of successive positions. A container dispenser is disposed at a first position along the conveyance system and is configured to selectively dispense a beverage container into an aligned one of the container receivers. A pouring assembly is disposed at a second position along the conveyance system, downstream of the container dispenser, and is configured to fill the beverage container with a beverage. A labeling system is disposed at a third position along the conveyance system, downstream of the pouring assembly, and is configured to apply a label to the filled beverage container. An access zone is defined at a fourth position along the conveyance system, downstream of the labeling system, where the filled beverage container can be retrieved. The system is configured as a modular system in which one or more additional stations selected from an additional pouring assembly, an ice dispensing station, a garnish station, a lid application station, and/or a container rinsing station can be added to and/or removed from the conveyance system and communicatively coupled to a control system.

In some embodiments, the conveyance system is a linear conveyor configured to move the container receivers in a single direction along a substantially straight path.

In some embodiments, the conveyance system is a carousel configured to move the container receivers along a closed-loop path.

An automated beverage dispensing system includes a conveyance system having a plurality of container receivers. A plurality of automated beverage dispensing stations are each disposed along the conveyance system. Each automated beverage dispensing station includes at least a container dispenser and a pouring assembly. A central venue controller is communicatively coupled to each of the plurality of automated beverage dispensing stations. The central venue controller is configured to receive beverage orders, distribute the beverage orders among the plurality of automated beverage dispensing stations based on at least one of a queue depth of each station, a beverage availability at each station, and/or a proximity of each station to a customer location within a venue, and aggregate data logs from the plurality of stations to generate venue-wide reports and analytics.

In some embodiments, the central venue controller is integrated with a venue point-of-sale system, an inventory management system, and/or a customer loyalty program.

### DESCRIPTION

The present specification discloses embodiments of an automated beverage dispensing system 20 that enables automated and optimized pouring of beverages, such as beer, in response to receiving electronic orders.

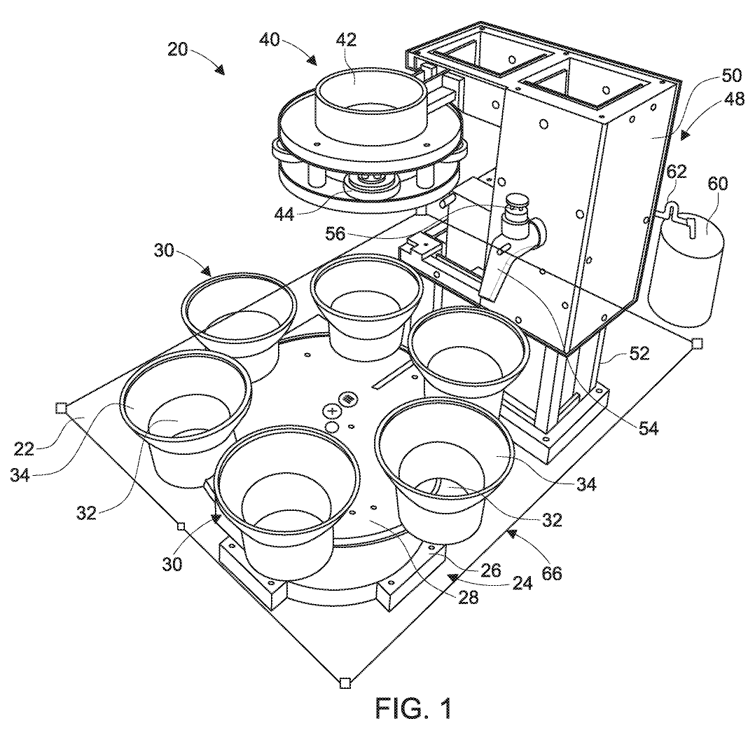

With initial reference to FIGS. 1-3, an embodiment of an automated beverage dispensing system 20 is supported on a platform such as a table 22. The system 20 comprises a carousel 24 having a base 26 upon which a rotating support 28 rests. A plurality of container receivers 30 – 6 in the illustrated embodiment – are supported by the rotating support 28. The rotating support 28 is coupled to a motor that enables and controls rotation. The container receivers 30 in the illustrated embodiment comprise tubular portions 32 and upper ends 34 that are substantially funnel shaped.

A container dispenser 40 is arranged to be above a portion of the carousel 24. The container dispenser 40 includes a tubular holding portion 42 configured to hold a stack of several containers 43, such as plastic cups. A dispensing structure 44, such as a gate, selectively opens to enable the bottom-most of the containers to drop by gravity into the tubular portion 32 of an awaiting container receiver 30 of the carousel 24. Preferably the container dispenser 40 and carousel 24 are configured so that rotation of the rotating support 28 can selectively align one of the container receivers 30 with the container dispenser’s holding portion 42 so that a container 43 dropped from the container dispenser 40 is readily received and supported by and in the container receiver 30.

A pouring assembly 48 comprises a pour body 50 supported by a pour base 52 in a manner so that the pour body 50 can be moved vertically up and down relative to the pour base 52 and carousel 24, preferably under the control of a motor. The pour body 50 supports a spigot 54, which includes a control valve 56 and which can be attached to a beverage source 60, such as a keg, via a flexible line 62.

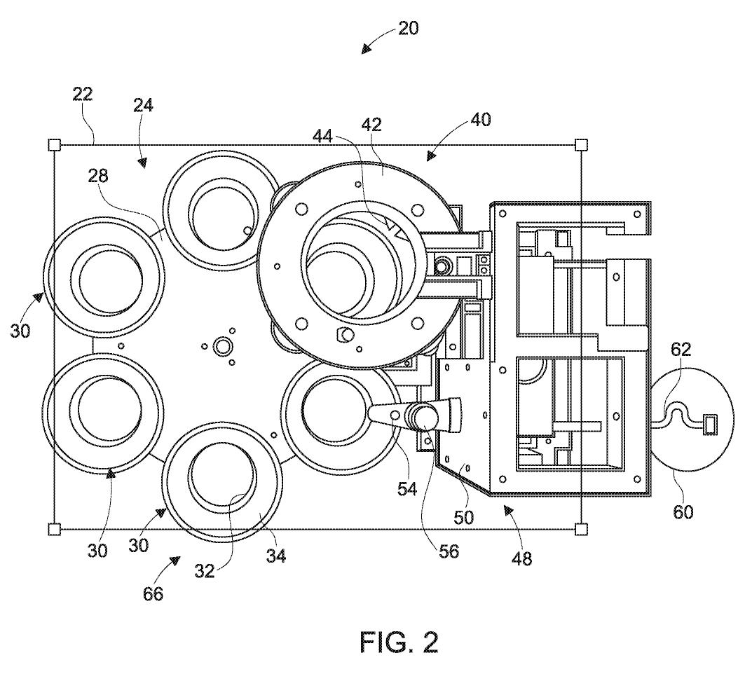

In the illustrated embodiment the carousel 24 is configured to move the container receivers 30 through a successive series of positions. For example, in FIGS. 1 and 2 one of the container receivers 30 is shown in a position aligned with the holding portion 42 of the container dispenser 40, while another container receiver 30 is shown in the next position, in which it is aligned with the spigot 54 of the pour body 50. Preferably, actuation of the carousel 24 successively moves the container receivers 30 through these and other positions as desired.

After a container 43 has been dispensed into a container receiver 30, the carousel 24 can be actuated to move the container receiver 30 forwardly one position so as to align the associated container 43 with the spigot 54. Operation of the pour body 50 can vertically lower the spigot 54 into the container 43, and the control valve 56 can be actuated (preferably electronically) to begin pouring of the beverage with the spigot 54 opening substantially at the bottom of the container 43. The pour body 50 can move vertically while the spigot 54 is pouring the beverage into the container 43 or as otherwise directed according to a preferred pouring procedure. Once pouring is complete, the pour body 50 can move vertically upwardly out of the container 43 and further upwardly above the container receiver 30 so as to provide clearance for the carousel 24 to rotate another position, moving the now-full container 43 into an access zone 66 in which a worker can access and remove the filled container 43 from the corresponding container receiver 30 for delivery to a customer.

It is to be understood that various sizes of containers 43 may be dispensed by the container dispenser 40. In some embodiments, a limit switch or other sensor can be arranged at or adjacent the pour base 52 to detect the size of the container 43 in the relevant container receiver 30. Such information can be communicated to a controller, which can direct the pouring assembly 48 to pour a volume of beverage corresponding to the detected container size.

Preferably, several sensor inputs can be received and considered by a control system of the beverage dispensing system 20. For example, sensors can determine whether or not a container 43 is being held in each one of the container receivers 30. Such sensor inputs can be delivered to a controller, which can comprise a computer processor and can be part of a control system also having memory and a user interface. The control system can also be connected to motors incorporated into and controlling structures such as the carousel 24, container dispenser 40, pouring assembly and the like, and can be configured to control each of these structures to work in concert with one another.

As an example, if a filled container 43 is not removed from its container receiver 30 through successive advancement through carousel positions, eventually the filled container 43 may be in the position adjacent the container dispenser 40. A sensor will detect the continued presence of this filled container 43 and communicate this to the control system, which may direct the carousel 24 to not advance further until the existing container 43 is removed. This will avoid a new container 43 being dispensed on top of an existing container 43. Sensors may also be arranged to verify proper alignment of the container receivers 30 with structures such as the container dispenser 40 and the spigot 54, and allow the system to direct adjustments as needed.

The automated beverage dispensing system 20 can incorporate a plurality of sensors of various types positioned at various locations throughout the system 20. The sensor data generated by these sensors can be communicated to the master controller 110 as sensor inputs 112, and the master controller 110 can use the sensor data to monitor the status of the system 20, to verify that operations are being performed correctly, to detect and respond to error conditions, and/or to control pouring operations in real time.

One or more container presence sensors can be configured to detect whether a container 43 is present within each container receiver 30 of the carousel 24. In some embodiments, a container presence sensor can be associated with each container receiver 30 and can travel with the container receiver 30 as the carousel 24 moves. In other embodiments, one or more container presence sensors can be arranged at fixed positions along the path of travel of the container receivers 30, such as at the container dispensing position, the pouring position, and/or the access zone 66, so that the presence or absence of a container 43 in a given container receiver 30 is detected as the container receiver 30 passes through each fixed sensor position. The container presence sensors can be optical sensors such as infrared break-beam sensors and/or retroreflective sensors, capacitive proximity sensors, inductive proximity sensors, mechanical limit switches, ultrasonic proximity sensors, and/or weight sensors such as load cells. In embodiments employing optical break-beam sensors, an emitter can be disposed on one side of the container receiver 30 and a receiver can be disposed on an opposing side of the container receiver 30 so that a container 43 within the container receiver 30 interrupts the optical beam, indicating the presence of the container 43. In embodiments employing load cells, a load cell can be disposed beneath and/or within each container receiver 30 so that the weight of a container 43, whether empty or filled, can be detected.

One or more container size sensors can be configured to detect the size of a container 43 within a container receiver 30. The container size sensors can be positioned at one or more locations along the path of travel of the container receivers 30. In some embodiments, one or more container size sensors can be disposed at or adjacent the pouring position so that the size of the container 43 is verified before the pour begins. In some embodiments, the container size sensors can comprise a plurality of optical break-beam sensors and/or proximity sensors arranged at different heights relative to the container receiver 30. For example, a first optical sensor can be positioned at a first height corresponding to the top edge of a small container 43, a second optical sensor can be positioned at a second height corresponding to the top edge of a medium container 43, and a third optical sensor can be positioned at a third height corresponding to the top edge of a large container 43. Based on which of the optical sensors detects the presence of the container 43, the master controller 110 can determine the size of the container 43. In other embodiments, the container size sensors can comprise an ultrasonic distance sensor and/or a laser distance sensor arranged above the container receiver 30 and directed downwardly so as to measure the distance from the sensor to the top edge and/or the bottom of the container 43 within the container receiver 30. Based on the measured distance, the master controller 110 can calculate the height of the container 43 and thereby determine the size of the container 43. In still other embodiments, the container size sensors can comprise one or more load cells disposed beneath and/or within the container receiver 30. Because different sizes of containers 43 can have different weights, the master controller 110 can determine the size of the container 43 based on the detected weight of the empty container 43 prior to the pour. In some embodiments, the load cell can also serve as the container presence sensor, providing both presence detection and size detection using a single sensor.

In some embodiments, containers 43 can include a machine-readable identifier such as a barcode, a QR code, an RFID tag, and/or a printed or embossed marking. A corresponding reader, such as a barcode scanner, a QR code scanner, an RFID reader, and/or an optical character recognition camera, can be positioned along the path of travel of the container receivers 30 and can be configured to read the machine-readable identifier on the container 43 as the container receiver 30 passes the reader. The machine-readable identifier can encode information such as the container size, the container type, and/or a container lot number. The reader can communicate the read information to the master controller 110 as part of the sensor inputs 112, and the master controller 110 can use the information to verify the container size, to select an appropriate pour procedure, and/or to associate the container 43 with a particular order.

One or more alignment sensors can be configured to verify that the container receivers 30 are properly aligned with one or more of the container dispenser 40, the spigot 54 of the pouring assembly 48, and/or the labeling system. In some embodiments, the alignment sensors can comprise a rotary encoder and/or a resolver coupled to a motor that drives the carousel 24. The master controller 110 can monitor the output of the rotary encoder to determine the angular position and/or linear position of the carousel 24, and can compare the determined position to a target position corresponding to proper alignment of a container receiver 30 with the relevant structure. In other embodiments, the alignment sensors can comprise one or more proximity sensors, such as inductive proximity sensors, Hall effect sensors, and/or optical sensors, arranged at fixed positions adjacent the carousel 24. Corresponding targets, such as metallic tabs, magnets, and/or reflective markers, can be disposed on the carousel 24 at positions corresponding to proper alignment of the container receivers 30 with the respective structures. When the proximity sensor detects the corresponding target, the master controller 110 can determine that the container receiver 30 is properly aligned and can halt movement of the carousel 24 at that position. In some embodiments, a combination of a rotary encoder for coarse positioning and a proximity sensor for fine positioning can be used, enabling the master controller 110 to rapidly move the carousel 24 to an approximately correct position using the rotary encoder and then precisely confirm alignment using the proximity sensor.

One or more hopper sensors can be configured to monitor the status of each hopper 96 of the container dispenser 40. In some embodiments, one or more hopper sensors can be configured to detect the quantity of containers 43 remaining within a hopper 96. For example, a weight sensor such as a load cell can be disposed beneath and/or coupled to each hopper 96 and can measure the weight of the stack of containers 43 within the hopper 96. The master controller 110 can calculate the approximate number of containers 43 remaining in the hopper 96 based on the measured weight and a known weight per container 43. In other embodiments, one or more optical sensors can be arranged at different heights along the hopper 96 to detect the level of the stack of containers 43 within the hopper 96. In still other embodiments, an ultrasonic sensor can be directed downwardly into the hopper 96 from the top of the tubular holding portion 42 to measure the distance from the sensor to the top of the container stack, enabling the master controller 110 to calculate the remaining stack height and thereby estimate the number of containers 43 remaining. In some embodiments, a low-level sensor can be disposed near the bottom of the hopper 96 and can be configured to trigger an alarm via the alarm 120 and/or a notification on the local interface 114 when the number of containers 43 in the hopper 96 falls below a threshold. The master controller 110 can also predict when a hopper 96 will become empty based on the current rate of container dispensing and can generate an advance warning to enable a worker to reload the hopper 96 before it is fully depleted.

One or more hopper identification sensors can be configured to verify which size of container 43 is loaded within each hopper 96. In some embodiments, the hopper identification sensors can comprise one or more proximity sensors and/or optical sensors arranged adjacent the dispensing structure 44 of each hopper 96 and configured to detect a dimension of the container 43 at or near the dispensing position. In other embodiments, the hopper identification sensors can comprise a machine-readable identifier reader, such as a barcode scanner, positioned to read a label on the hopper 96 and/or on the bottom-most container 43 in the hopper 96. In still other embodiments, the hopper identification sensors can comprise a mechanical sensor such as a gauge or a feeler that physically contacts the container 43 at the dispensing position and detects a dimension of the container 43, such as a diameter or a height. The hopper identification sensor data can be communicated to the master controller 110, which can use the data to confirm that the correct size of container 43 is loaded in each hopper 96 and/or to update an internal record of which hopper 96 holds which size of container 43.

One or more temperature sensors can be configured to measure the temperature of the beverage in each source 60 and/or in each flexible line 62. The temperature sensors can be thermocouples, thermistors, resistance temperature detectors, and/or infrared temperature sensors. In some embodiments, a temperature sensor can be coupled to the exterior of the source 60 such as a keg and can measure the surface temperature of the source 60, from which the temperature of the beverage within the source 60 can be inferred. In other embodiments, a temperature sensor can be disposed within the flexible line 62, in contact with the beverage flowing through the flexible line 62, so as to directly measure the temperature of the beverage. The temperature data can be communicated to the master controller 110 and can be used by the master controller 110 as a factor in selecting an appropriate pour procedure from the database 116, as described above.

One or more ambient environment sensors can be configured to measure conditions in the environment surrounding the automated beverage dispensing system 20. The ambient environment sensors can include an ambient temperature sensor, a barometric pressure sensor, and/or a humidity sensor. The ambient environment data can be communicated to the master controller 110 and can be used by the master controller 110 as additional factors in selecting and/or adjusting pour procedures. For example, a higher ambient temperature can increase the tendency of a beverage to generate foam, and the master controller 110 can account for this by selecting a pour procedure that specifies a lower flow rate and/or a slower spigot withdrawal rate. In some embodiments, an elevation value can be stored in the memory of the master controller 110 and/or can be determined by the master controller 110 based on the barometric pressure reading.

As discussed above, one or more flow sensors can be disposed in the flexible lines 62 and can be configured to measure the volume and/or flow rate of beverage passing through the flexible lines 62 during each pour. The flow sensors can be turbine flow sensors, electromagnetic flow sensors, ultrasonic flow sensors, and/or Coriolis flow sensors. The flow sensor data can be communicated to the master controller 110 in real time during the pour, and the master controller 110 can use the flow sensor data to precisely control the volume of beverage dispensed, to calculate remaining beverage volume in the source 60, and/or to detect anomalies such as a blocked line and/or an empty source 60.

As also discussed above, one or more fill-level sensors can be configured to detect the liquid level and/or foam level within the container 43 during and/or after the pour. In some embodiments, a fill-level sensor can be arranged on and/or adjacent the pour base 52 and can be directed toward the container 43 in the pouring position. In other embodiments, a fill-level sensor can be mounted on the pour body 50 and can move with the pour body 50 during the pour. The fill-level sensor can be an ultrasonic sensor configured to emit ultrasonic pulses and detect reflections from the liquid surface and/or foam surface within the container 43, an optical sensor such as a laser distance sensor configured to measure the distance to the liquid surface and/or foam surface, and/or a capacitive sensor configured to detect changes in capacitance as the liquid level within the container 43 changes. In some embodiments, a camera can be positioned to capture images of the container 43 during and/or after the pour, and the master controller 110 can process the captured images using image recognition algorithms to determine the liquid level and/or foam height within the container 43.

One or more foam sensors can be configured to specifically detect the presence, height, and/or density of foam on the beverage within the container 43 during and/or after the pour. In some embodiments, the foam sensor can be an optical sensor, such as an infrared sensor and/or a camera, configured to distinguish between the liquid portion and the foam portion of the beverage based on differences in optical characteristics such as reflectivity, opacity, and/or color. In other embodiments, the foam sensor can be an ultrasonic sensor configured to detect the boundary between the foam and the liquid based on differences in acoustic impedance. Data from the foam sensors can be used by the master controller 110 to evaluate the quality of each pour and/or to provide real-time feedback for adaptive pour control as described above.

One or more dispensing confirmation sensors can be configured to verify that a container 43 has been properly dispensed from the container dispenser 40 into the aligned container receiver 30. In some embodiments, a dispensing confirmation sensor can be positioned at or adjacent the dispensing position and can be configured to detect the passage of a container 43 as it drops from the hopper 96 into the container receiver 30. The dispensing confirmation sensor can be an optical break-beam sensor positioned between the hopper 96 and the container receiver 30, a proximity sensor positioned adjacent the container receiver 30, and/or a load cell disposed beneath the container receiver 30 that detects a change in weight corresponding to the arrival of the container 43. If the dispensing confirmation sensor does not detect a successful dispensing event within an expected time after the dispensing structure 44 has been actuated, the master controller 110 can generate an alarm and/or can re-attempt the dispensing operation.

The master controller 110 can be configured to aggregate and process all of the sensor inputs 112 described above in a coordinated manner so as to maintain a comprehensive real-time model of the status of the automated beverage dispensing system 20. Such a model can include the position of the carousel 24, the presence and/or absence of a container 43 in each container receiver 30, the size of each container 43, the fill status of each container 43, the temperature of each beverage source 60, the ambient environmental conditions, the remaining quantity of containers 43 in each hopper 96, and/or the estimated remaining volume of beverage in each source 60. The master controller 110 can use this real-time model to make operational decisions, to detect and respond to error conditions, to optimize the sequence and timing of operations, and/or to generate reports and alerts for workers and/or administrators.

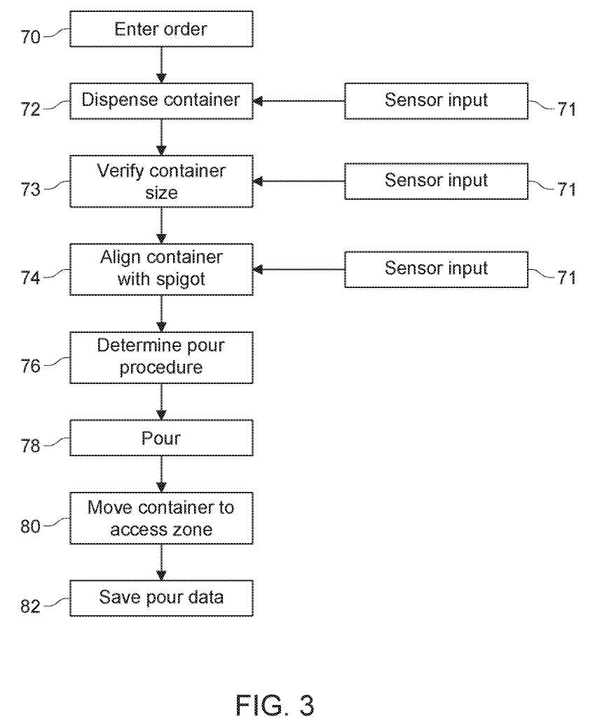

With particular reference to FIG. 3, in operation, a user can enter 70 an order into the system via a user interface. The order can be communicated to the control system, which will direct that a container 43 be dispensed 72 from the container dispenser 40 into an awaiting container receiver 30. Sensor inputs 71 will be considered to ensure that the container receiver 30 is properly aligned with the container dispenser 40 and open to receive a container 43. Sensor inputs 71 can also verify 73 the size of the container 43.

The system may direct the carousel 24 to move forward one position so as to align 74 the dispensed container 43 with the spigot 54. Sensor inputs 71 can again ensure correct alignment. The system will determine 76 the correct pour procedure for the particular beverage, and will direct the pouring assembly to perform an appropriate pour 78 to fill the container 43 with the beverage in accordance with the selected pour procedure.

Once the pour is complete, the carousel 24 can be directed to move 80 the container receiver 30 forwardly another position away from the pour assembly 48 to an access zone 66 in which a user can remove the filled container 43 for delivery to a customer. Sensors can detect whether the container 43 is still within the container receiver 30, and thus the controller can determine whether the filled container 43 has been removed from the carousel 24 for delivery to the customer.

Data concerning the pour, such as the user ordering the pour, the identity of the customer, the selected beverage, the volume of beverage dispensed, an order number, and the like, can be retained and saved 82 by the controller. Such data can be compiled into statistical analyses, and can also be used to predict when the keg 60 needs to be changed or other features of the source 60 need to be modified, maintained or the like.

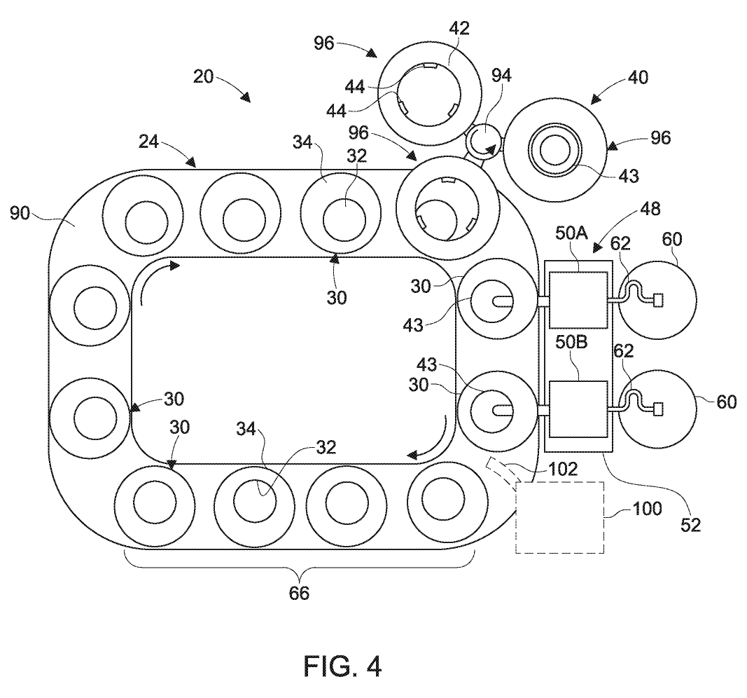

With reference next to FIGS. 4-6, another embodiment of an automatic beverage dispensing system 20 is depicted. The illustrated system comprises a carousel 24 supporting a plurality of container receivers 30 configured to move along a track 90. The illustrated track 90 can be oblong, oval, circular or other shapes. A motor can selectively move the container receivers 30 clockwise from position to successive position around the track 90. The container receivers 30 preferably are sized and configured to receive a plurality of different sizes of containers 43 therewithin. In one embodiment, a group of compatible containers 43 are configured with different volumes, but have some dimensions in common so that each size of container 43 can fit in the container receiver 30. For example, one group of compatible containers 43 can include 16 oz., 20 oz., and 24 oz. plastic cups that have substantially the same open top diameter, and similar bottom diameters, but different lengths so as to provide different volumes while each size remains compatible with the container receiver 30.

The container receivers 30 can be configured to physically accommodate a plurality of different sizes of containers 43 without requiring adjustment and/or reconfiguration of the container receivers 30 between pours. In some embodiments, each container receiver 30 can have a tapered interior profile in which the interior diameter of the tubular portion 32 narrows from the upper end 34 toward the lower end of the tubular portion 32. A larger container 43 can seat higher within the tapered interior profile, while a smaller container 43 can seat deeper within the tapered interior profile, and each size of container 43 can be supported by friction and/or contact between the exterior of the container 43 and the interior surface of the tubular portion 32 at the point where the container diameter corresponds to the interior diameter of the tubular portion 32. As such, the funnel-shaped upper end 34 of each container receiver 30 can serve as a guide that directs each container 43 downwardly into the tubular portion 32 regardless of the size of the container 43, and the tapered interior of the tubular portion 32 can receive and support each size of container 43 at a corresponding depth.

In some embodiments, the interior of each container receiver 30 can include one or more stepped portions. Each stepped portion can define a shoulder at a corresponding interior diameter, and each size of container 43 can seat on the shoulder that corresponds to the exterior diameter of that container 43. For example, a first shoulder at a larger interior diameter can support a large container 43, a second shoulder at a smaller interior diameter and disposed below the first shoulder can support a medium container 43, and a third shoulder at a still smaller interior diameter and disposed below the second shoulder can support a small container 43. As such, different sizes of containers 43 can be received and supported at different depths within the same container receiver 30 without requiring any modification of the container receiver 30.

In some embodiments, each container receiver 30 can include one or more removable inserts configured to adapt the container receiver 30 to a particular size of container 43. For example, a cylindrical insert having an interior diameter sized to receive a small container 43 can be placed within the tubular portion 32 of the container receiver 30 when small containers 43 are to be used. The insert can be removed and replaced with a different insert having a different interior diameter when a different size of container 43 is to be used, or the insert can be removed entirely when the largest size of container 43 is to be used. In some embodiments, the inserts can be color-coded and/or labeled to indicate the size of container 43 with which each insert is associated.

In some instances, each container receiver 30 can include one or more resilient gripping elements disposed on the interior surface of the tubular portion 32. The resilient gripping elements can be flexible fingers, spring-loaded pads, elastomeric rings, and/or inflatable bladders. The resilient gripping elements can flex and/or compress to accommodate different exterior diameters of different sizes of containers 43, and can exert a gripping force on the exterior of the container 43 so as to securely hold the container 43 within the container receiver 30 during movement of the carousel 24. In embodiments employing inflatable bladders, the master controller 110 can control inflation and deflation of the bladders so as to grip the container 43 during carousel movement and release the container 43 when the container 43 is to be removed at the access zone 66.

In embodiments in which the group of compatible containers 43 have substantially the same open top diameter but different heights, the open top of each size of container 43 can be at approximately the same position relative to the upper end 34 of the container receiver 30, or can be at different positions depending on the depth at which the container 43 seats within the container receiver 30. The master controller 110 can account for the position of the open top of the container 43 when directing the pour body 50 to lower the spigot 54 into the container 43. For example, the master controller 110 can determine the size of the container 43 based on sensor data and can calculate a corresponding starting depth for the spigot 54 so that the spigot 54 is lowered to the appropriate depth within the container 43 regardless of the container size. In some embodiments, the starting depth for each container size can be stored in the database 116 as part of the pour procedure associated with each combination of beverage and container size.

In some embodiments, the group of compatible containers 43 can include containers 43 of different shapes in addition to or instead of different heights. For example, the group can include a standard straight-walled cup, a tapered cup, and/or a contoured cup, each having a different volume but configured to fit within the container receiver 30. The master controller 110 can determine the shape and/or type of the container 43 based on sensor data and/or based on information associated with the hopper 96 from which the container 43 was dispensed, and can select an appropriate pour procedure accordingly.

Regarding the container dispenser 40, the rotating mount 94 supporting the plurality of hoppers 96 can be configured to rotate to any angular position so as to align any one of the hoppers 96 with the aligned container receiver 30. In the illustrated embodiment, three hoppers 96 are provided, but in other embodiments two, four, five, or more hoppers 96 can be supported by the rotating mount 94. In some embodiments, the hoppers 96 can be evenly spaced about the rotating mount 94, and in other embodiments the hoppers 96 can be unevenly spaced. Each hopper 96 can be removably coupled to the rotating mount 94 so that individual hoppers 96 can be removed for refilling, cleaning, and/or replacement with hoppers 96 holding a different size and/or type of container 43.

In some embodiments, the container dispenser 40 can comprise a linear arrangement of hoppers 96 instead of a rotating mount 94. The hoppers 96 can be arranged side by side, and a linear actuator can be configured to translate the linear arrangement of hoppers 96 so as to selectively align one of the hoppers 96 with the aligned container receiver 30 on the carousel 24. In other alternative embodiments, the hoppers 96 can be fixed in position, and a diverter mechanism such as a chute, a conveyor, and/or a robotic arm can be configured to receive a container 43 dispensed from a selected hopper 96 and deliver the container 43 to the aligned container receiver 30.

In still other alternative embodiments, the container dispenser 40 can comprise a single hopper 96 that holds a single size of container 43 at a time. When a different size of container 43 is needed, a worker can reload the hopper 96 with the appropriate size of container 43, or the master controller 110 can generate a notification directing the worker to do so. In such embodiments, the system 20 can be configured to queue orders by container size, filling all orders for a first container size before transitioning to a second container size, so as to minimize the frequency of hopper reloading.

The master controller 110 can implement a container size verification procedure in which the expected size of the container 43 is compared to the detected size of the container 43 at one or more stages of the dispensing and pouring process. When the master controller 110 directs the container dispenser 40 to dispense a container 43 of a particular size, the master controller 110 can record the expected size as part of the order data associated with the corresponding container receiver 30. After the container 43 has been dispensed into the container receiver 30 and/or after the carousel 24 has advanced the container receiver 30 to the pouring position, one or more container size sensors can detect the size of the container 43 within the container receiver 30, and the detected size can be communicated to the master controller 110.

The master controller 110 can compare the detected size to the expected size. If the detected size matches the expected size, the master controller 110 can proceed with the pouring operation. If the detected size does not match the expected size, the master controller 110 can initiate one or more error-handling actions. In some embodiments, the error-handling actions can include setting an alarm condition via the alarm 120, generating a notification on the local interface 114 and/or the administrative interface 122 identifying the mismatch and the affected container receiver 30, and/or halting advancement of the carousel 24 until the error is resolved. In some embodiments, the master controller 110 can direct the carousel 24 to continue advancing the container receiver 30 holding the mismatched container 43 past the pouring position without performing a pour, and can direct the carousel 24 to deliver the mismatched container 43 to the access zone 66 for manual removal by a worker. The master controller 110 can then re-queue the affected order for fulfillment with the correct container size.

In some embodiments, the master controller 110 can determine that the detected size, although different from the expected size, is nonetheless acceptable for the order. For example, if the order specifies a medium beverage and the detected container 43 is a large container 43, the master controller 110 can present an option on the local interface 114 for a worker to approve filling the large container 43 with the medium-sized volume of beverage, or the master controller 110 can automatically approve such a substitution according to a predefined rule. In other embodiments, the master controller 110 can reject any size mismatch and can require that the mismatched container 43 be removed and replaced with the correct size before proceeding.

The master controller 110 can maintain an internal record associating each container receiver 30 with data about the container 43 currently held within that container receiver 30. Such data can include the container size, the container type, the order number, the beverage identity, the fill status (empty, being filled, filled), and/or the position of the container receiver 30 on the carousel 24. As the carousel 24 advances, the master controller 110 can update the position data for each container receiver 30 and can use the internal record to track the status of every container 43 in the system 20 at any given time. The internal record can enable the master controller 110 to coordinate the operations of the container dispenser 40, the pouring assembly 48, the labeling system, and/or the electronic displays 104 so that each component acts upon the correct container 43 at the correct time.

In some embodiments, the master controller 110 can use the internal record to implement an order prioritization and sequencing algorithm. For example, if the pouring assembly 48 comprises a first pour body 50A connected to a first beverage source 60 and a second pour body 50B connected to a second beverage source 60, the master controller 110 can sequence the orders so that a container 43 for the first beverage is dispensed into the container receiver 30 that will align with the first pour body 50A, and a container 43 for the second beverage is dispensed into the container receiver 30 that will align with the second pour body 50B. In this manner, the master controller 110 can maximize the utilization of the pour bodies 50 by ensuring that each pour body 50 has a container 43 to fill whenever possible, and can minimize idle time for the system 20. In some embodiments, the master controller 110 can reorder queued orders and/or delay dispensing of certain containers 43 so as to optimize the sequence of pour body assignments, container sizes, and/or beverage types.

Along these lines, a container dispenser 40 can be disposed adjacent the carousel 24. The illustrated container dispenser 40 comprises a rotating mount 94 that supports three hoppers 96. Each hopper 96 comprises a tubular holding portion 42 configured to hold a stack of containers 43, such as plastic cups. A dispensing structure 44, such as a gate, selectively opens to enable the bottom-most of the containers 43 to drop by gravity to an awaiting container receiver 30 of the carousel 24, which preferably has been aligned with the subject holding portion 42 so that the container 43 dropped from the container dispenser 40 is readily received and supported by and in the container receiver 30. The rotating mount 94 can be rotated by a motor so as to align a selected one of the hoppers 96 with the container receiver 30 on the carousel 24. In operation, a different size of container 43 can be held in each of the hoppers 96. As such, the present system enables pouring of three different sizes of beverages.

Continuing with reference to FIGS. 4-6, a pouring assembly 48 is configured to fill containers 43 in the carousel 24 with a preferred beverage. In the illustrated embodiment the pouring assembly 48 comprises a first pour body 50A and a second pour body 50B, each of which is supported by and movable relative to a pour base 52. Each pour body 50 comprises a spigot 54 that includes an electronically-actuable valve and is attached via a flexible line 62 to a beverage source 60, such as a beer keg. The pour bodies 50 are arranged adjacent one another and spaced one carousel position away from one another so that the spigot 54 of each pour body 50 can simultaneously be aligned with a different corresponding container receiver 30. The pour bodies 50 are configured to be vertically movable so that the corresponding spigot 54 can be lowered into a container 43 that is held in the aligned container receiver 30, enabling a controlled pour configured to control foam creation during the pour in a desired manner. The pour body 50 can be raised during the pouring motion in a manner as desired to create an ideal or optimal foam head for the associated beverage, such as beer.

In the illustrated embodiment, two pour bodies 50 are provided and are controllable independent of one another. In other embodiments, more or less pour bodies 50 can be provided as desired. Provision of multiple pour bodies increases both the efficiency and versatility of the system. For example, in some embodiments, both pour bodies 50 can be connected to the same beverage source 60. As such, the system 20 can pour more of that popular beverage at a time, and service times can be improved. In the illustrated embodiment the pour bodies 50 are connected to different sources, enabling the system to dispense more than one beverage. In still other embodiments, more than one beverage source 60 can be connected to each spigot 54, and a valve mechanism can be actuated to select which of the sources provide the beverage for each pour. As such, each pour body 50 can be used to pour more than one beverage, as selected. In still other embodiments, the spigot 54 types may differ between pour bodies 50. For example, one of the spigots 54 can include a sparkler, which is designed to entrain more air during the pour. Thus, even if both pour bodies 50 are connected to the same beverage source 60, the pour characteristics of the pour body 50 with the conventional spigot 54 will be different than those of the pour body 50 with the specialty sparkler spigot 54.

As depicted schematically in FIG. 4, a label printer 100 can be disposed adjacent the carousel 24. An applicator portion 102 of the printer 100 can reach outwardly so as to be interposed in the path of container receivers 30 as they move along the carousel track 90, preferably immediately after the pouring assembly 48. The label printer 100 can print a label with information about the beverage and/or order corresponding to the next-in-line filled container 43, and push the printed label onto the applicator 102, which adheres the label to the corresponding container 43 as it passes by on the carousel 24. As such, each of the filled containers 43 can be labeled with identifying information so as to ensure delivery to the correct customer.

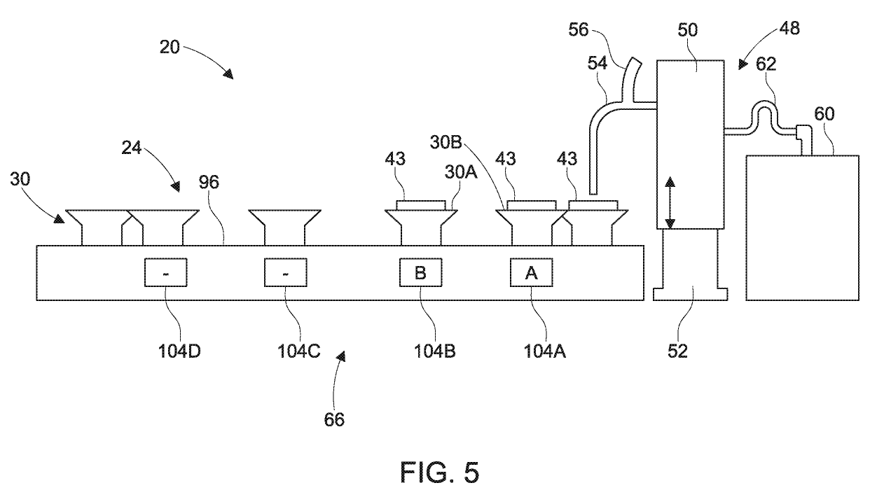

In another embodiment, and with specific reference to FIG. 5, for each position of the container receivers 30 in an access zone 66 after the pouring assembly 48, an electronic display 104 can be arranged on a side of the carousel 24 adjacent each container receiver position. The display 104 can be configured to display information about the order and/or beverage in the corresponding filled container 43. As the carousel 24 moves, and the container receiver 30 moves to the next position, the information about that container/order correspondingly moves one position to the next electronic display 104. When a user removes the filled container 43 from the container receiver 30, presumably for delivery to a customer, a sensor can detect that the container has been removed, and the electronic display 104 stops displaying the order information.

As can be imagined, the automated beverage dispensing system 20 can employ a plethora of electric motors, sensors and controllers to accompany and operate the structures featured therein. Further, a master control system 110 – whether disposed centrally as a localized processor or distributed between a plurality of controllers, or even remotely via online connections – can be configured to control all the features to properly work together, communicating information and taking actions to properly identify, pour, and deliver the correct beverage.

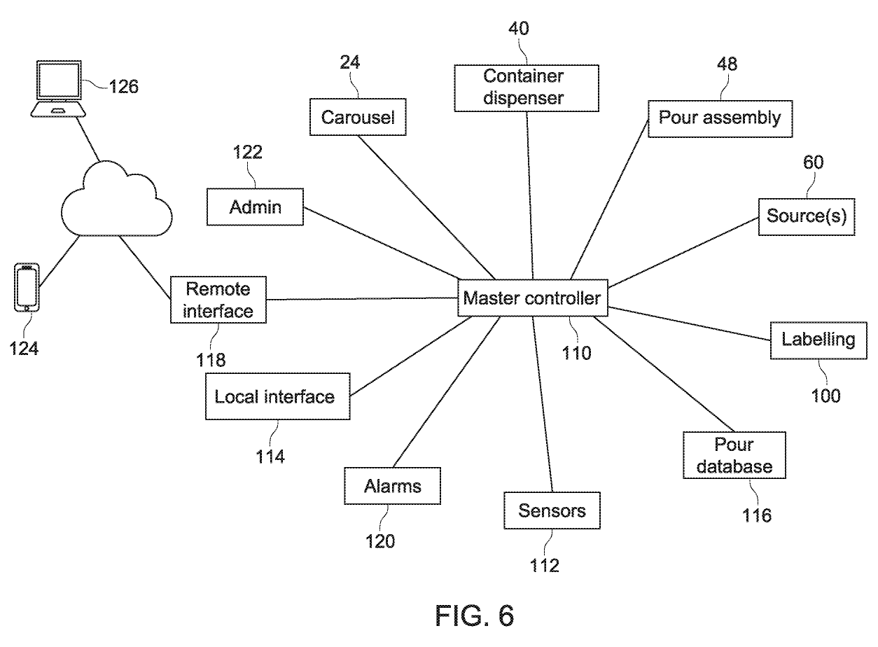

With particular reference now to FIG. 6, in a schematic representation of the automatic beverage dispensing system 20, a master controller 110 has one or more computer processors as well as software and hardware configured to receive information such as order request and sensor inputs 112, to communicate instructions to other devices and controllers, such as motors and controllers, and to direct operation of the system in response to the information it has received.

In one embodiment, a user can enter a local order via a local interface 114, such as a worker receiving the order request from a customer and entering the order using a user interface of a computing machine such as a cash register. The order preferably includes an identity of the desired beverage, along with its size and, in some embodiments, other information. In some instances an identity of the customer can also be entered. The system 110 can assign an order number to the order. Also, in some instances a single customer order can include a plurality of beverages. Each of the beverages can be part of the same order, but individual beverages will have their own suborder number to enable proper tracking. The local order can be communicated to the master controller 110, which will direct fulfillment. It should be understood that multiple registers can be assigned to the same master controller, and thus multiple local orders can be entered in near simultaneous time.

For example purposes, the present discussion will use an example having three container sizes: small, medium and large, and generally assume two different beverages, for example, beer A and beer B.

In a given example, a first customer order A is a medium beverage of beer A and a second customer order B is a large beverage of beer B. The master controller 110 thus directs the container dispenser 40 to dispense a medium-sized container 43 into an aligned first container receiver 30A. As noted above, the container dispenser 40 has three hoppers 96. The first hopper is loaded with small-sized containers 43; the second hopper is loaded with medium-size containers 43; and the third hopper is loaded with large-size containers 43. In some embodiments, the hoppers have sensors, such as a limit switch or the like, to verify which size of container 43 is held within the particular hopper 96. This information is communicated to the master controller 110 so that the controller knows to actuate the rotating mount 94 to align the correct hopper with the aligned container receiver 30. Alternatively, or in addition, when a user loads the hoppers the user can indicate which size of container 43 is in which hopper 96.

When the medium-sized container 43 is dispensed to the container receiver 30A, the carousel 24 can actuate to move the container receiver 30A one position forward. A sensor such as a limit switch can be disposed on or adjacent the carousel 24 and can again determine the size of the container 43 within container receiver 30A, and communicate this information to the controller 110. The controller 110 can then compare the expected size (here, medium), with the detected size (here also medium) to ensure the correct size of container 43 is disposed within the container receiver 30A. At this stage the second container receiver 30B is aligned with the container dispenser 40. If the detected size container 43 in container receiver 30A meets expectation, the controller 110 can then direct the container dispenser 40 to rotate the hoppers 96 and dispense a large-size container 43 into container receiver 30B. When that task is complete the controller will direct the carousel 24 to move to the next position, which will result in container receiver 30A being aligned with the spigot 54 of pour body 50A and container receiver 30B being aligned with the spigot 54 of pour body 50B. Beer A is connected to pour body 50A, and beer B is connected to pour body 50B. The pour bodies 50 can be directed to simultaneously pour the respective beer into the cups in their aligned container receivers 30. The controller 110 directs pour body 50A to pour a medium-sized volume of beer A into the medium-sized container 43 in container receiver 30A and directs pour body 50B to pour a large-sized volume of beer B into the large-sized container in container receiver 30B, which actions can occur substantially simultaneously.

Each of the pour bodies 50 communicate with the controller 110 when their particular task is complete. The controller 110 will note and save the volume poured of each of beer A and beer B, and can recalculate and update an estimated volume of beverage remaining in the source 60 of each of beer A and beer B.

The controller 110 will have, by this time, communicated to the labelling system 100 and/or 104 that container receiver 30A includes order A, which is the medium-sized cup of beer A, and container receiver 30B includes order B, which is the large-sized cup of beer B. In an embodiment using printed labels, the printer will print a label with order A information. Once pouring is complete, the controller 110 will direct the carousel 24 to move one position, during which operation the printer 100 can apply the label for order A onto the medium-sized cup in container receiver 30A. The controller 110 will direct the carousel 24 to move to the next position, and the printer 100 will print and apply the label for order B onto the large-sized cup in container receiver 30B. Notably, during this operation it is anticipated that further orders are being filled in the container receivers 30 behind the example receivers.

Alternatively, or in addition, immediately after the pouring system 48 has completed pouring orders A and B, the controller 110 can direct the carousel 24 to move two positions so that the container receiver 30A is aligned with electronic display 104B and container receiver 30B is aligned with electronic display 104A. The controller 110 will direct electronic display 104A to display information about order B and electronic display 104B to display information about order A. Presumably, other orders are being poured and, when complete, the carousel 24 will again move. The controller will direct further electronic displays 104 to display order information about the order in the aligned container receiver 30. When a user removes the medium-sized cup from receiver 30A, a sensor will detect that receiver 30A is now empty. This information will be relayed to the controller 110, which will update its status of container receiver 30A and will direct the corresponding electronic display 104 to stop displaying information about order A.

A database 116 including information and procedures in connection with each of the beverages being poured can be maintained in communication with the controller 110. Such database 116 can be local to the controller 110 or, in some embodiments, maintained remotely and accessed, for example, through an online connection. Different beers may have different optimum pouring procedures, in which changing the pour speed and spigot depth during the pour in a particular way may be optimal for the particular beer. Thus, in some embodiments, the controller 110 will access the pour procedure database 116, select the pour procedure best matching the order, and direct the relevant pour body 50/spigot 54 to pour the particular beer according to the selected procedure, which may be different from beer to beer and even between orders. Also, sometimes the same beer may have a different pouring procedure based on other factors, such as the temperature of the beer, the temperature of the surrounding atmosphere, and the type of spigot 54 used. For example, for a given beer the optimum pour procedure using a spigot having a sparkler attachment may be different than for a common-type spigot.

In view of these considerations, the controller 110 can be manually updated with information such as the spigot 54 type for each pour body 50 as well as the particular beverage(s) connected to each pour body 50, and sensor inputs 112 can provide additional information such as the temperature of the beverage in each source 60/keg, as well as the surrounding environmental temperature, barometric pressure, elevation, etc.

Further, the order information can include customization considerations, such as whether the customer wishes a tall head or a short head. Each beer may have a different procedure for pouring a tall head than for pouring a short head, and, depending on the procedure stored in the database 116 and the customization request included in the order, the controller 110 will direct the pour body 50 to operate according to the selected procedure in order to satisfy the order request.

Each pour procedure stored in the database 116 can define a plurality of parameters that, taken together, govern how the pouring assembly 48 fills a particular container 43 with a particular beverage. Such parameters can include, without limitation, a starting depth of the spigot 54 within the container 43, a spigot withdrawal profile defining how and when the spigot 54 is raised during the pour, a valve opening profile defining the degree to which the control valve 56 is opened over the course of the pour, a target pour volume, a total pour time, and/or one or more pause intervals during which the control valve 56 is temporarily closed or restricted while the spigot 54 remains within the container 43.

In some embodiments, a pour procedure can comprise a body-fill phase and a head-generation phase. During the body-fill phase, the spigot 54 can be positioned at or near the bottom of the container 43 and the control valve 56 can be opened to a first degree so as to deliver the beverage at a first flow rate. Delivering the beverage with the spigot 54 submerged near the bottom of the container 43 can reduce turbulence and limit premature foam generation during the body-fill phase. As the liquid level rises within the container 43, the pour body 50 can raise the spigot 54 at a controlled rate so that the spigot 54 remains at or near the rising liquid surface, or at a defined depth below the liquid surface. During the head-generation phase, the control valve 56 can be adjusted to a second degree, which can be greater than or less than the first degree, and/or the spigot 54 can be raised to a position at or above the liquid surface so as to introduce a controlled amount of turbulence that generates a desired amount of foam head on the beverage. The relative durations of the body-fill phase and the head-generation phase, the flow rates during each phase, and/or the spigot depth profile during each phase can differ from one pour procedure to another.

In some embodiments, one or more intermediate phases can be defined between the body-fill phase and the head-generation phase. For example, a transition phase can include a pause interval during which the control valve 56 is closed or substantially restricted, allowing foam generated during the body-fill phase to partially settle before the head-generation phase begins. Such a pause interval can improve consistency of the resulting foam head by enabling the pour to account for the settling characteristics of the particular beverage. The duration of the pause interval can be defined by the pour procedure and can vary based on the beverage type, the carbonation level of the beverage, the temperature of the beverage, and/or the type of spigot 54 being used.

The valve opening profile defined by a pour procedure can specify a fixed valve position for the entirety of the pour, or can specify a variable valve position that changes over the course of the pour. For example, a pour procedure for a highly carbonated beverage can specify a relatively low initial valve opening that gradually increases as the container 43 fills, thereby managing foam generation as back-pressure within the container 43 changes. Conversely, a pour procedure for a less carbonated beverage such as a nitrogenated stout can specify a relatively high initial valve opening followed by a reduction during the head-generation phase. In embodiments in which the control valve 56 is an electronically-actuatable proportional valve, the master controller 110 can continuously or periodically adjust the valve position during the pour in accordance with the valve opening profile of the selected pour procedure.

The spigot withdrawal profile defined by a pour procedure can specify the vertical position of the spigot 54 relative to the container 43 as a function of time and/or as a function of the volume of beverage dispensed. In some embodiments, the spigot withdrawal profile can be defined as a series of discrete depth values each associated with a corresponding time or volume threshold. In other embodiments, the spigot withdrawal profile can be defined as a continuous function, such as a linear or non-linear ramp. The master controller 110 can direct the pour body 50 to move the spigot 54 in accordance with the spigot withdrawal profile by controlling a motor coupled to the pour body 50.

The database 116 can store a plurality of pour procedures corresponding to a plurality of different beverages. In some embodiments, the database 116 can store multiple pour procedures for the same beverage, each corresponding to a different set of conditions. For example, a first pour procedure for a given beer can be associated with a beverage temperature in a first temperature range, and a second pour procedure for the same beer can be associated with a beverage temperature in a second temperature range that is higher than the first temperature range. The second pour procedure can specify, for example, a lower initial flow rate and/or a different spigot withdrawal profile relative to the first pour procedure so as to account for the increased tendency of warmer beer to generate foam due to the decrease in the solubility of carbon dioxide with increasing temperature. Similarly, different pour procedures for the same beverage can be associated with different ambient temperatures, different barometric pressures, different elevations, different spigot types (such as a conventional spigot versus a sparkler spigot), different container sizes, and/or different customer preferences such as a tall head versus a short head.

When the master controller 110 receives an order, the master controller 110 can select the appropriate pour procedure from the database 116 based on a combination of factors. Such factors can include the identity of the ordered beverage, the size of the container 43, the spigot type of the pour body 50 that will perform the pour, a detected temperature of the beverage in the source 60, a detected ambient temperature, a detected barometric pressure, an elevation value, and/or one or more customer preferences included in the order. In some embodiments, the master controller 110 can apply a selection algorithm that identifies the stored pour procedure having the closest match to the detected combination of factors. In other embodiments, the master controller 110 can interpolate between two or more stored pour procedures to generate a modified pour procedure that is tailored to the specific detected conditions.

In some embodiments, the database 116 can be updated remotely. For example, a beverage producer such as a brewery can develop and/or refine optimized pour procedures for its beverages and can transmit the updated pour procedures to the master controller 110 via a network connection such as the internet. The master controller 110 can receive the updated pour procedures and store them in the database 116, replacing or supplementing previously stored pour procedures for the corresponding beverage. As such, the pour procedures used by the automated beverage dispensing system 20 can be continuously improved over time without requiring manual intervention at the system location. In some embodiments, the administrative interface 122 can enable an administrator to review, approve, and/or modify remotely received pour procedures before they are applied by the master controller 110.

In some embodiments, the automated beverage dispensing system 20 can incorporate adaptive pour control. One or more sensors can be configured to monitor characteristics of the beverage during and/or after the pour. For example, a fill-level sensor can be arranged adjacent the pouring assembly 48 and can be configured to detect the liquid level and/or foam level within the container 43 during the pour. The fill-level sensor can be an ultrasonic sensor, an optical sensor, a capacitive sensor, and/or a weight sensor such as a load cell disposed beneath or within the container receiver 30. The master controller 110 can receive data from the fill-level sensor during the pour and can compare the detected fill level to an expected fill level defined by the selected pour procedure. If the detected fill level deviates from the expected fill level by more than a threshold amount, the master controller 110 can adjust one or more pour parameters in real time. For example, the master controller 110 can adjust the valve opening, the spigot withdrawal rate, and/or the pour duration so as to bring the pour back into conformance with the desired outcome.

In some embodiments, a foam sensor can be configured to detect the height and/or density of the foam head on the beverage during and/or after the pour. The foam sensor can be an optical sensor such as a camera or an infrared sensor, and/or an ultrasonic sensor. Data from the foam sensor can be communicated to the master controller 110, which can use the data to evaluate the quality of the pour. If the detected foam height is less than a target foam height, the master controller 110 can extend the head-generation phase or increase turbulence during the head-generation phase. If the detected foam height exceeds the target foam height, the master controller 110 can shorten the head-generation phase, reduce the flow rate, and/or introduce a pause interval to allow excess foam to settle before completing the pour.

In some embodiments, the master controller 110 can use data collected during pours to refine and improve the pour procedures stored in the database 116 over time. For example, the master controller 110 can log the pour parameters used for each pour along with sensor data indicative of the quality of the resulting pour, such as the foam height, the fill level, and/or the total volume dispensed. The master controller 110 can analyze the logged data to identify correlations between pour parameters and pour quality under various conditions, and can update the stored pour procedures based on the analysis. Such updates can be performed automatically by the master controller 110 using a machine learning algorithm, and/or can be performed manually by an administrator via the administrative interface 122 after reviewing reports generated from the logged data.

A flow sensor can be disposed in the flexible line 62 between the source 60 and the spigot 54 of each pour body 50. The flow sensor can be configured to measure the volume of beverage flowing through the flexible line 62 during each pour. The master controller 110 can receive flow data from the flow sensor and can use the flow data to precisely control the volume of beverage dispensed into each container 43. For example, the master controller 110 can close the control valve 56 when the measured volume reaches the target pour volume defined by the selected pour procedure. The flow sensor data can also be used by the master controller 110 to calculate and update an estimated volume of beverage remaining in the source 60, enabling the master controller 110 to generate an alarm via the alarm 120 when the estimated remaining volume falls below a threshold and/or to predict when the source 60 will need to be replaced.

With continued reference to FIG. 6, in some embodiments a remote order method is provided via a remote interface 118. For example, a user seated at a numbered seat at an event venue can employ a personal computing device such as a smartphone 124 with a user interface 118 to access a remote ordering system. Once the order is placed, including both the order specifics and information such as the customer’s location/seat number, the control system functions to satisfy the order. Preferably, however, the label with order information includes the user location, and a delivery worker can deliver the poured beverage order to the customer at their seat. Alternatively, the customer can remotely order a beverage to be poured and ready at a specific time for the customer to pick it up. The master controller 110 preferably includes a clock so that it can schedule filling of this order at the requested time, notwithstanding the time at which the order was actually placed.

The remote interface 118 can be implemented as a software application executable on the customer's personal computing device such as the smartphone 124, a tablet computer, a laptop computer, and/or a wearable computing device such as a smartwatch, smartglasses, or other type of smart device. In some embodiments, the remote interface 118 can be a native application installed on the personal computing device. In other embodiments, the remote interface 118 can be a web-based application accessible via a web browser on the personal computing device. In still other embodiments, the remote interface 118 can be accessed by the customer scanning a machine-readable code such as a QR code displayed at the customer's seat, at a venue entrance, on a printed menu, and/or on a display screen within the venue. Upon scanning the machine-readable code, the customer's personal computing device can open the remote interface 118 in a web browser and/or launch the native application, and the machine-readable code can encode information identifying the venue, the automated beverage dispensing system 20, and/or the customer's location within the venue such as a seat number, a section number, and/or a table number.

The remote interface 118 can present a menu of available beverages to the customer. The menu can be dynamically generated by the master controller 110 based on the beverages currently connected to the pouring assembly 48. For example, the master controller 110 can maintain a record of the beverage identity associated with each pour body 50 and/or each beverage source 60, and can transmit this information to the remote interface 118 so that the menu displays only beverages that are currently available for pouring. In some embodiments, the menu can also display information about each available beverage, such as the beverage name, a description, the alcohol content, the style and/or type, the brewery and/or producer, a price, and/or an image. The menu information can be stored in the database 116 and/or in a separate menu database maintained by the master controller 110 and/or by a remote server.

When a beverage source 60 is depleted and/or disconnected, the master controller 110 can update the menu to remove the corresponding beverage and/or to display a notification that the beverage is no longer available. When a new beverage source 60 is connected, the master controller 110 can update the menu to add the corresponding beverage. In some embodiments, the menu can display an estimated number of remaining servings for each beverage based on the estimated remaining volume in the corresponding source 60 as tracked by the master controller 110. Such information can enable customers to place orders before a popular beverage is depleted.

The remote interface 118 can enable the customer to select a beverage from the menu, select a container size from the available sizes, and/or specify one or more customization preferences. Customization preferences can include a desired head height such as a tall head, a standard head, and/or a short head, a desired pour style, and/or any other customer-selectable option that the master controller 110 can accommodate by selecting an appropriate pour procedure from the database 116. The remote interface 118 can display a summary of the customer's selections and a total price before the customer confirms the order.

In some embodiments, the remote interface 118 can enable the customer to place a group order comprising a plurality of beverages in a single transaction. The group order can include different beverages, different container sizes, and/or different customization preferences for each beverage within the group. The master controller 110 can receive the group order and can assign a single order number to the group order and a suborder number to each individual beverage within the group. The master controller 110 can queue the individual beverages of the group order for fulfillment and can track the fulfillment status of each suborder.

In some embodiments, the remote interface 118 can enable the customer to establish a tab, which is a running account associated with the customer's identity and/or payment information. The customer can place multiple orders over time against the tab, and each order can be added to the tab without requiring a separate payment transaction for each order. At the conclusion of the customer's visit, the customer can close the tab via the remote interface 118 and/or via the local interface 114, at which point a single payment transaction can be processed for the total amount of all orders placed against the tab. The master controller 110 can maintain tab data for each active tab and can enforce configurable limits on the tab, such as a maximum number of beverages, a maximum total amount, and/or a maximum number of beverages within a defined time period.

The remote interface 118 can provide the customer with order status updates throughout the fulfillment process. Upon placing an order, the remote interface 118 can display an order confirmation including the order number, the selected beverage and container size, the customization preferences, and/or the estimated fulfillment time as calculated by the master controller 110. As the order progresses through the pipeline of the automated beverage dispensing system 20, the master controller 110 can transmit status updates to the remote interface 118. Status updates can include notifications such as "order received," "container dispensed," "pouring in progress," "pouring complete," and/or "ready for pickup" and/or "ready for delivery." The status updates can be displayed within the remote interface 118 application and/or can be transmitted to the customer's personal computing device as push notifications.

In embodiments in which the customer has ordered the beverage for delivery to the customer's seat, the master controller 110 can transmit the order information including the customer's seat number, section number, and/or table number to a worker interface. The worker interface can be displayed on a computing device accessible to a delivery worker, such as a tablet computer, a smartphone 124, a wearable computing device, and/or the local interface 114. The delivery worker can view the order information, retrieve the filled container 43 from the access zone 66, and deliver the filled container 43 to the customer at the indicated location. The worker interface can enable the delivery worker to confirm delivery of the order, and the confirmation can be communicated to the master controller 110, which can update the order status to "delivered" and can transmit a delivery confirmation to the customer via the remote interface 118.

In embodiments in which the customer has ordered the beverage for pickup, the master controller 110 can transmit a ready notification to the customer's personal computing device via the remote interface 118 when the filled container 43 has reached the access zone 66. The ready notification can include information such as the order number, the location of the automated beverage dispensing system 20 within the venue, and/or a pickup window during which the filled container 43 will remain available at the access zone 66. In some embodiments, the master controller 110 can monitor whether the filled container 43 is removed from the container receiver 30 within the pickup window. If the filled container 43 is not removed within the pickup window, the master controller 110 can generate a reminder notification to the customer via the remote interface 118 and/or can generate an alert to a worker via the local interface 114 to address the unretrieved container 43.

In some embodiments in which the customer has specified a desired pickup time, the master controller 110 can calculate a target pour start time by subtracting an estimated fulfillment duration from the requested pickup time. The estimated fulfillment duration can account for the current queue depth, the estimated pour time for the ordered beverage, the estimated labeling time, and/or the estimated number of carousel positions between the pouring position and the access zone 66. The master controller 110 can hold the order in the queue until the target pour start time and can then initiate fulfillment so that the filled container 43 arrives at the access zone 66 at approximately the requested pickup time. In some embodiments, the master controller 110 can adjust the target pour start time dynamically based on changes in queue depth and/or system throughput so as to maintain the requested pickup time as closely as possible.

In some embodiments, the remote interface 118 can include a venue map feature that displays a map of the venue and the locations of one or more automated beverage dispensing systems 20 within the venue. The customer can view the map to identify the nearest system 20 and/or the system 20 with the shortest estimated wait time, and can select the desired system 20 before placing the order. The venue map can be updated in real time by the master controller 110 and/or by a central venue controller to reflect the current estimated wait time, the available beverages, and/or the operational status of each system 20.

In some embodiments, the remote interface 118 can provide a reorder feature that enables the customer to quickly reorder a previously ordered beverage with the same container size and customization preferences. The remote interface 118 can display the customer's order history and can enable the customer to select a previous order for reorder with a single interaction such as a tap and/or a click. The master controller 110 can receive the reorder request and can queue the order for fulfillment using the same parameters as the prior order.

In some embodiments, the remote interface 118 can enable the customer to provide feedback on the poured beverage, such as a rating, a comment regarding the foam quality, and/or a comment regarding the temperature. The feedback can be transmitted to the master controller 110 and/or to the administrative interface 122. In some embodiments, the master controller 110 can associate the customer feedback with the pour data for the corresponding order, including the pour procedure used, the pour parameters, and/or the sensor data collected during the pour. Such associated data can be used by administrators and/or by the adaptive pour control algorithms described above to evaluate and/or refine the pour procedures stored in the database 116.

In some embodiments, the remote interface 118 can implement geofencing and/or proximity detection so that the remote ordering functionality is available only when the customer's personal computing device is within a defined geographic area corresponding to the venue and/or within a defined proximity to the automated beverage dispensing system 20. Geofencing can be implemented using GPS data from the customer's personal computing device, and proximity detection can be implemented using Bluetooth beacons, Wi-Fi signal strength, and/or near-field communication. Such location restrictions can help prevent orders from being placed by customers who are not physically present at the venue.

It is anticipated that problems may occasionally arise. For example, as discussed above, a filled container 43 may not be timely removed from its container receivers 30 so that it is in the position next to the container dispenser 40. In such a situation, when a sensor input 112 indicates that such a problem has arisen, the master controller 110 can set an alarm condition, preventing further movement of the carousel 24 and triggering an alarm 120, which may be an audible or visual alarm, and may include a message on a user interface imploring a worker to address the situation. Further alarm conditions may be triggered, for example, when the sensor inputs 112 suggest that the expected container size is different than the detected container size, when any one of the hoppers is or is sensed to be nearly empty, and when the source 60/keg has been calculated or sensed to be either nearly empty or has become totally empty. Other alarm conditions are also contemplated.

With continued reference to FIG. 6, an administrative interface 122 can be electronically linked to the master controller 110 so that analyses, statistics, and operational parameters can be monitored and adjusted locally or remotely by an administrator system having its own administrative processor, hardware and software. Such administrator system can reside locally adjacent the system or elsewhere in the building in according with a network, and/or can be online, enabling administrators to have access to the system via computing devices such as mobile computing devices 124 and desktop computing systems 126.

The master controller 110 can comprise one or more computer processors, one or more memory devices, one or more communication interfaces, and/or one or more input/output interfaces. The one or more computer processors can be microprocessors, microcontrollers, field-programmable gate arrays, application-specific integrated circuits, and/or system-on-chip devices. The one or more memory devices can include volatile memory such as random-access memory and/or non-volatile memory such as flash memory, solid-state drives, and/or hard disk drives. The memory devices can store software instructions executable by the one or more computer processors, configuration data, order data, sensor data logs, pour procedure data, and/or operating system software. The one or more communication interfaces can include wired interfaces such as Ethernet, USB, RS-485, and/or CAN bus interfaces, and/or wireless interfaces such as Wi-Fi, Bluetooth, Zigbee, and/or cellular interfaces. The one or more input/output interfaces can include digital input and output ports, analog input ports, and/or serial communication ports for communicating with sensors, motors, valves, displays, and/or other peripheral devices of the automated beverage dispensing system 20.

In some embodiments, the master controller 110 can be implemented as a single computing device, such as an industrial computer, a single-board computer, and/or a programmable logic controller, that is disposed locally within and/or adjacent to the automated beverage dispensing system 20. In other embodiments, the master controller 110 can be implemented as a distributed control system comprising a plurality of controllers that communicate with one another over a communication bus and/or network. For example, a carousel controller can be dedicated to controlling the motor and sensors associated with the carousel 24, a dispensing controller can be dedicated to controlling the container dispenser 40 and its associated motors and sensors, a pour controller can be dedicated to controlling the pouring assembly 48 and its associated motors, valves, and sensors, and/or a labeling controller can be dedicated to controlling the labeling system. Each of these dedicated controllers can communicate with a central coordinator, which can be a separate computing device or can be one of the dedicated controllers designated as the coordinator. The central coordinator can receive order requests, maintain the order queue, and issue high-level instructions to each dedicated controller, while each dedicated controller can manage the detailed timing and execution of its assigned operations. Such a distributed architecture can provide advantages in modularity, scalability, and/or fault isolation, in that a failure of one dedicated controller can be detected and managed without necessarily disabling the entire system 20.

In still other embodiments, the master controller 110 can be implemented at least in part as a cloud-based computing system accessible via the internet and/or a local area network. In such embodiments, a local gateway device disposed adjacent the automated beverage dispensing system 20 can communicate with the sensors, motors, valves, and/or other peripheral devices of the system 20, and can relay data to and receive instructions from the cloud-based computing system. The cloud-based computing system can perform computationally intensive tasks such as order optimization, data analytics, machine learning, and/or pour procedure refinement, while the local gateway device can perform time-sensitive tasks such as real-time motor control, valve actuation, and/or sensor monitoring. Such a hybrid architecture can enable the automated beverage dispensing system 20 to benefit from the computational resources of the cloud while maintaining responsive local control of the physical components.

The master controller 110 can execute control software that implements a state machine and/or a pipeline model for managing the container receivers 30 as they move through the successive positions of the carousel 24. In a pipeline model, each container receiver 30 can be in one of a plurality of defined states at any given time. The defined states can include, without limitation, an empty state in which the container receiver 30 does not hold a container 43, a dispensing state in which the container receiver 30 is aligned with the container dispenser 40 and a container 43 is being and/or has been dispensed into the container receiver 30, a verification state in which the size of the container 43 in the container receiver 30 is being detected and/or verified, a pouring state in which the container 43 in the container receiver 30 is being filled with beverage by the pouring assembly 48, a labeling state in which a label is being applied to and/or information is being displayed for the container 43 in the container receiver 30, an access state in which the container receiver 30 is in the access zone 66 and the filled container 43 is available for retrieval, and/or an alarm state in which an error condition has been detected with respect to the container receiver 30 and/or its container 43. The master controller 110 can maintain a data structure that records the current state of each container receiver 30, and can transition each container receiver 30 from one state to the next as the carousel 24 advances and operations are performed.

The pipeline model can enable the master controller 110 to coordinate simultaneous operations at different positions along the carousel 24. For example, while a first container receiver 30 is in the pouring state and a pour is being performed, a second container receiver 30 can simultaneously be in the dispensing state and receiving a container 43 from the container dispenser 40, a third container receiver 30 can simultaneously be in the labeling state and receiving a label from the labeling system, and/or one or more additional container receivers 30 can simultaneously be in the access state in the access zone 66. The master controller 110 can track and coordinate all of these simultaneous operations so that each operation is performed correctly and in proper sequence. When all operations at the current set of positions are complete, the master controller 110 can direct the carousel 24 to advance one position, causing each container receiver 30 to transition to the next state in the pipeline. In some embodiments, the master controller 110 can determine that one or more positions are clear to advance while others are not, and can delay advancement of the carousel 24 until all active operations at the current positions are complete.

The master controller 110 can maintain an order queue that stores a plurality of pending orders awaiting fulfillment. Each order in the order queue can include data such as an order number, a suborder number for each individual beverage within the order, a beverage identity, a container size, one or more customer preferences such as a desired head height, a customer identity, a customer location such as a seat number, a timestamp indicating when the order was placed, and/or a requested fulfillment time. The master controller 110 can process the order queue in a first-in-first-out sequence, or can implement a prioritization algorithm that reorders the queue based on one or more factors.

In some embodiments, the prioritization algorithm can consider factors such as the requested fulfillment time, the beverage identity, the container size, and/or the availability of the pour bodies 50. For example, if the pouring assembly 48 comprises a first pour body 50A connected to a first beverage and a second pour body 50B connected to a second beverage, the master controller 110 can reorder the queue so that orders for the first beverage and orders for the second beverage are interleaved in a manner that maximizes the simultaneous utilization of both pour bodies 50. As another example, if several orders for the same beverage and the same container size are queued in sequence, the master controller 110 can batch these orders together so that the container dispenser 40 does not need to rotate the hoppers 96 between consecutive dispensing operations, thereby reducing cycle time.

In some embodiments, the master controller 110 can calculate an estimated fulfillment time for each order based on the current queue depth, the current position of each container receiver 30, the estimated pour time for each pending order, and/or the current operating status of the system 20. The estimated fulfillment time can be communicated to the local interface 114 and/or the remote interface 118 so that a worker and/or a customer can be informed of the expected wait time. In embodiments employing the remote interface 118, the estimated fulfillment time can be transmitted to the customer's personal computing device such as the smartphone 124 as a push notification and/or as a real-time update within a remote ordering application.

The master controller 110 can be configured to handle order modifications and/or order cancellations. In some embodiments, a worker can modify and/or cancel a pending order via the local interface 114, and/or a customer can modify and/or cancel a pending order via the remote interface 118, provided that the order has not yet progressed beyond a modifiable state. For example, if the container 43 for the order has not yet been dispensed into a container receiver 30, the master controller 110 can remove the order from the queue and/or update the order data to reflect the modification. If the container 43 has already been dispensed but the pour has not yet begun, the master controller 110 can determine whether the modification can be accommodated without removing the container 43. For example, if the modification changes the beverage from a first beverage to a second beverage but the container size remains the same, the master controller 110 can update the order data and direct the appropriate pour body 50 to pour the second beverage into the container 43. If the modification changes the container size, the master controller 110 can flag the container receiver 30 for manual removal of the incorrect container 43, can advance the container receiver 30 through the carousel 24 without performing a pour, and can re-queue the modified order for fulfillment with the correct container size.

The master controller 110 can be configured to detect and respond to a plurality of error conditions. Error conditions can include, without limitation, a container size mismatch as described above, a container dispensing failure in which a container 43 is not successfully dispensed into the container receiver 30, a pour failure in which the flow sensor detects no flow and/or insufficient flow during a pour, a carousel jam in which the alignment sensors indicate that the carousel 24 has not reached the target position within an expected time, a hopper depletion in which a hopper 96 is empty and/or below a low-level threshold, a source depletion in which the estimated remaining volume of beverage in the source 60 is at and/or below a threshold, a labeling failure in which the labeling system reports an error, and/or a container overflow in which a fill-level sensor detects that the liquid level within the container 43 has exceeded a maximum threshold. For each error condition, the master controller 110 can be configured to execute a corresponding error-handling routine. Error-handling routines can include halting the carousel 24, closing the control valve 56 of the affected pour body 50, generating an alarm via the alarm 120, generating a notification on the local interface 114 and/or the administrative interface 122, skipping the affected container receiver 30 and continuing with subsequent orders, and/or re-queuing the affected order for a subsequent attempt.

In some embodiments, the master controller 110 can implement a failsafe mode in the event of a loss of power, a loss of communication with one or more peripheral devices, and/or a software fault. In the failsafe mode, the master controller 110 can close all control valves 56, halt all motors, and/or generate an alarm. The master controller 110 can store the current state of the system 20, including the state of each container receiver 30 and the order queue, in non-volatile memory so that the state can be recovered when power is restored and/or the fault is resolved. Upon recovery, the master controller 110 can resume operations from the saved state, and can present a recovery interface on the local interface 114 enabling a worker to review the state of the system 20, confirm and/or discard partially completed orders, and/or reset the system 20 to an initial state.

The master controller 110 can maintain a data log recording information about each order processed by the automated beverage dispensing system 20. The data log can include, for each order, the order number, the timestamp, the beverage identity, the container size, the customer identity and/or customer location, the pour body 50 used, the pour procedure selected, the actual pour parameters including the pour duration and the volume dispensed as measured by the flow sensor, the detected foam height, the container receiver 30 used, the time at which the filled container 43 was removed from the container receiver 30, and/or any error conditions encountered during fulfillment of the order. The data log can be stored locally in the memory of the master controller 110 and/or can be transmitted to a remote storage system via a network connection.

The master controller 110 and/or the administrative interface 122 can generate reports and/or statistical analyses based on the data log. Such reports can include, without limitation, a total volume of each beverage dispensed over a selected time period, a total number of orders fulfilled over a selected time period, an average fulfillment time per order, a distribution of container sizes ordered, a distribution of beverages ordered, peak ordering times, an estimated remaining volume of beverage in each source 60, a projected time at which each source 60 will need to be replaced, a frequency and type of error conditions encountered, and/or a comparison of actual pour volumes to target pour volumes. Such reports can enable administrators to monitor the performance of the system 20, to identify trends and/or issues, to manage inventory, and/or to make informed decisions about staffing, beverage selection, and/or system maintenance. The administrators may be owners of the machine, of the establishment, may be local to the machine’s location, or may be located remotely and can verify the system from a distance.

In some embodiments, the master controller 110 can be configured to generate automated notifications based on the data log and/or real-time operational data. For example, the master controller 110 can transmit a notification to the administrative interface 122 and/or to a mobile computing device 124 of an administrator when the estimated remaining volume of a beverage in a source 60 falls below a threshold, when the number of containers 43 in a hopper 96 falls below a threshold, when the error rate exceeds a threshold over a defined time period, and/or when the average fulfillment time exceeds a threshold. Such automated notifications can enable administrators to proactively address operational issues without requiring continuous manual monitoring of the system 20.

In embodiments in which a venue includes a plurality of automated beverage dispensing systems 20, the master controllers 110 of the respective systems 20 can be communicatively coupled to one another and/or to a central venue controller via a network. The central venue controller can coordinate operations across the plurality of systems 20, such as distributing incoming orders among the systems 20 based on factors such as the queue depth of each system 20, the beverage availability at each system 20, and/or the proximity of each system 20 to the customer's location within the venue. The central venue controller can also aggregate data logs from the plurality of systems 20 to generate venue-wide reports and analytics. In some embodiments, the central venue controller can be integrated with a venue point-of-sale system, an inventory management system, and/or a customer loyalty program so that order data, inventory data, and/or customer data can be shared between the automated beverage dispensing systems 20 and other venue systems.

In some embodiments, the master controller 110 can be configured to integrate with third-party payment processing systems. For example, when a customer places an order via the remote interface 118, the master controller 110 and/or a payment processing module communicatively coupled to the master controller 110 can process a payment transaction using the customer's payment information, such as a credit card number, a digital wallet, and/or a venue-specific payment account. The master controller 110 can withhold fulfillment of the order until the payment transaction is confirmed. In embodiments in which orders are placed via the local interface 114, the local interface 114 can be integrated with a cash register and/or point-of-sale terminal that processes the payment transaction, and the order can be transmitted to the master controller 110 after the payment is confirmed.

In some embodiments, the master controller 110 can be configured to enforce age verification requirements for beverages such as beer and/or other alcoholic beverages. When a customer places an order via the remote interface 118, the remote ordering application can prompt the customer to provide proof of age, such as a date of birth, a scanned image of an identification document, and/or a previously stored age verification credential. The master controller 110 can verify the customer's age based on the provided information and can reject the order if the customer's age does not meet a minimum age threshold. In embodiments in which orders are placed via the local interface 114, a worker can verify the customer's age manually, and can confirm the age verification via the local interface 114 before the order is accepted by the master controller 110.

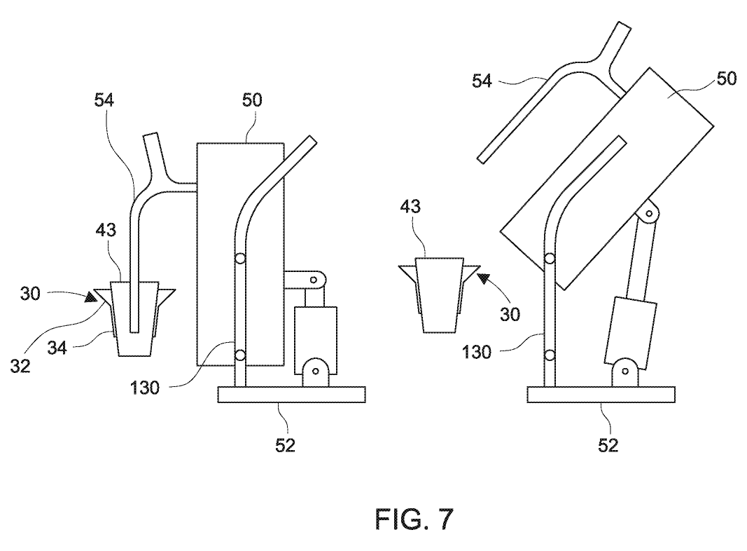

With reference next to FIG. 7, in additional embodiments the pour body 50 can be configured to move the spigot 54 out of alignment with the container receiver 30 when not performing the pouring function. For example, in the illustrated embodiment, each pour body 50 is mounted in a body track 130 supported by the pour base 52. The body track 130 is configured so that, after the pour is complete, continued pushing of the pour body 50 upwardly directs the spigot 54 out of alignment with the aligned container receiver 30, by translating the pour body 50 backwards, tilting the pour body 50, or both. As such, when the carousel 24 subsequently moves to the next position, any possible dripping from the pour body spigot 54 will not enter the container 43 that may be in the position corresponding to the pour body 50. Such container 43 may have already been filled with another beverage. Preventing drips from encountering such container 43 will prevent contamination of one poured beverage with drips from another beverage.

In additional embodiments, instead of a body track 130 as illustrated, a first motor can be configured to move the pour body 50 up and down, and a second motor can be configured to move the pour body 50 forwardly and rearwardly. In still additional embodiments the pour body 50 can be supported by a linkage that is configured to move the pour body spigot 54 out of alignment with the container receiver 30 while not pouring. In still further embodiments the pour body can be configured to rotate after pouring is complete in order to take the associated spigot out of alignment with the adjacent container receiver 30.

The displacement of the spigot 54 out of alignment with the container receiver 30 after a pour is complete can address the situation in which different beverage sources 60 are connected to different pour bodies 50. In such a configuration, after a first pour body 50 completes a pour of a first beverage into a container 43 and the carousel 24 advances, a different container 43 that was previously filled with a second beverage by a second pour body 50 can move into the position beneath the first pour body 50. Any residual liquid remaining on or within the spigot 54 of the first pour body 50 can drip downwardly. If the spigot 54 of the first pour body 50 remains aligned with the container receiver 30, such drips of the first beverage can fall into the container 43 that has been filled with the second beverage, thereby contaminating the second beverage with the first beverage. Displacing the spigot 54 out of alignment with the container receiver 30 after the pour is complete can direct any such drips to fall outside of the container 43, thereby preventing cross-contamination between beverages.

With further reference to FIG. 7, the body track 130 can define a guided path along which the pour body 50 travels during and after a pour. In some embodiments, the body track 130 can comprise a channel, a rail, a slot, and/or a groove formed in or coupled to the pour base 52. The pour body 50 can include one or more followers, such as rollers, pins, and/or slides, that engage the body track 130 and constrain the movement of the pour body 50 to the path defined by the body track 130. The body track 130 can define a first portion that is substantially vertical and a second portion that deviates from vertical. During a pour, the pour body 50 can travel along the first portion of the body track 130 so that the spigot 54 moves substantially vertically downward into the container 43 and substantially vertically upward during and after the pour. When the pour body 50 is raised beyond the first portion and into the second portion of the body track 130, the second portion can direct the pour body 50 rearwardly, laterally, and/or at an angle away from the container receiver 30 so that the spigot 54 is displaced out of vertical alignment with the container receiver 30.

In some embodiments, the second portion of the body track 130 can be curved so as to smoothly transition the pour body 50 from the vertical travel path of the first portion to the displaced position of the second portion. For example, the body track 130 can define a J-shaped profile, an L-shaped profile, and/or a cam-shaped profile when viewed from a side of the pour base 52. In a J-shaped profile, the first portion extends vertically and the second portion curves rearwardly and optionally upwardly so that the pour body 50 is both raised and displaced rearwardly when the pour body 50 reaches the upper extent of the body track 130. In an L-shaped profile, the first portion extends vertically and the second portion extends substantially horizontally so that the pour body 50 translates rearwardly after reaching the top of the vertical travel. In a cam-shaped profile, the body track 130 can define a contoured path that provides a desired combination of vertical and horizontal displacement as the pour body 50 moves along the body track 130.

In some embodiments, the second portion of the body track 130 can include a detent, a latch, and/or a friction feature configured to retain the pour body 50 in the displaced position until the pour body 50 is actively driven back toward the pouring position for a subsequent pour. Such a retention feature can prevent the pour body 50 from drifting back toward alignment with the container receiver 30 under the influence of gravity and/or vibration between pours.

In the embodiments in which the body track 130 tilts the pour body 50, the tilting can direct the spigot 54 to an orientation that is angled away from the container receiver 30. For example, the pour body 50 can be tilted rearwardly so that the distal end of the spigot 54 points rearwardly and/or upwardly relative to the carousel 24. In such an orientation, any residual liquid on the spigot 54 can drip rearwardly away from the container receiver 30 and/or can be retained on the spigot 54 by surface tension rather than dripping downwardly into the container receiver 30.

In the embodiments employing a first motor and a second motor in lieu of the body track 130, the first motor can be a linear actuator, a lead screw motor, a belt-driven actuator, and/or a rack and pinion drive configured to move the pour body 50 vertically relative to the pour base 52. The second motor can be a linear actuator, a lead screw motor, a belt-driven actuator, and/or a rack and pinion drive configured to move the pour body 50 horizontally relative to the pour base 52. The master controller 110 can independently control the first motor and the second motor so as to move the pour body 50 along a desired path. For example, during a pour, the master controller 110 can actuate the first motor to lower and raise the spigot 54 vertically while maintaining horizontal alignment with the container receiver 30. After the pour is complete and the spigot 54 has been raised above the container 43, the master controller 110 can actuate the second motor to translate the pour body 50 horizontally so as to displace the spigot 54 out of alignment with the container receiver 30. In some embodiments, the master controller 110 can actuate both the first motor and the second motor simultaneously so that the pour body 50 follows a diagonal or curved path as it moves from the pouring position to the displaced position.

In the embodiments employing a linkage, the pour body 50 can be supported by a multi-bar linkage coupled to the pour base 52. The linkage can be configured so that actuation of a single motor coupled to the linkage causes the pour body 50 to follow a predetermined path that includes both a vertical component and a horizontal component. For example, a four-bar linkage can be configured so that rotation of a drive link causes the pour body 50 to descend substantially vertically during a first portion of the drive link's rotation and to retract rearwardly and/or laterally during a second portion of the drive link's rotation. In some embodiments, the linkage can include a coupler link coupled to the pour body 50, a drive link coupled to the motor and to the coupler link, and a ground link defined by the pour base 52. The geometry of the linkage members can be selected so that the path of the pour body 50 closely approximates a desired combination of vertical travel during the pour and horizontal displacement after the pour.

In the embodiments in which the pour body 50 is configured to rotate, the pour body 50 can be pivotally coupled to the pour base 52 at a pivot point. A motor can be configured to rotate the pour body 50 about the pivot point. During a pour, the pour body 50 can be oriented so that the spigot 54 is directed downwardly into the container 43. After the pour is complete and the spigot 54 has been raised above the container 43, the motor can rotate the pour body 50 about the pivot point so that the spigot 54 swings laterally, rearwardly, and/or upwardly out of alignment with the container receiver 30. The angle of rotation can be, for example, between about 15 degrees and about 180 degrees, and can be selected based on the spacing between adjacent container receivers 30 and the length of the spigot 54 so as to ensure that the distal end of the spigot 54 is displaced sufficiently to prevent drips from entering an adjacent container 43.

In some embodiments, regardless of the particular displacement mechanism employed, a drip tray can be positioned to receive residual liquid that drips from the spigot 54 when the spigot 54 is in the displaced position. The drip tray can be coupled to the pour base 52 and/or to the carousel 24 and can be positioned beneath the displaced position of the spigot 54. The drip tray can include a drain coupled to a waste line so that collected liquid is directed away from the automated beverage dispensing system 20. In some embodiments, the drip tray can be removable for cleaning and/or replacement.

In some cases, a rinse mechanism can be configured to direct a cleaning fluid, such as water, over and/or through the spigot 54 when the spigot 54 is in the displaced position. For example, one or more rinse nozzles can be positioned adjacent the displaced position of the spigot 54 and can be configured to spray water onto the exterior of the spigot 54 and/or to direct water through the interior of the spigot 54 so as to flush residual beverage from the spigot 54 before the next pour. The rinse mechanism can be actuated by the master controller 110, for example, when the pour body 50 is being switched from a first beverage source 60 to a second beverage source 60, and/or between each pour as a routine sanitation measure. Rinse water can be collected by the drip tray and directed to the waste line.

In embodiments in which the pouring assembly 48 includes a plurality of pour bodies 50, each pour body 50 can include its own displacement mechanism, and the displacement mechanisms can be the same or different from one another. For example, a first pour body 50A can employ a body track 130 while a second pour body 50B can employ a two-motor arrangement. In other embodiments, all of the pour bodies 50 can employ the same type of displacement mechanism. Each displacement mechanism can be independently controlled by the master controller 110 so that each pour body 50 can be displaced from and returned to its pouring position independently and at different times, as dictated by the sequence of pouring operations being performed.

The embodiments discussed above have disclosed structures with substantial specificity. This has provided a good context for disclosing and discussing inventive subject matter. However, it is to be understood that other embodiments may employ different specific structural shapes and interactions.

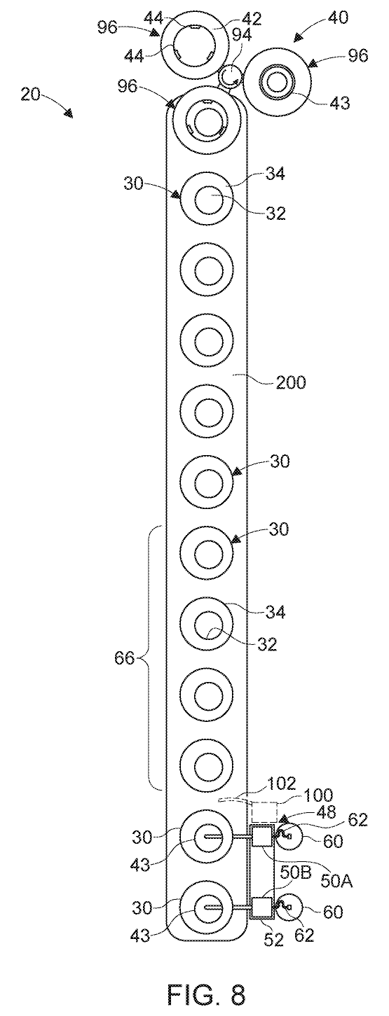

With reference now to FIG. 8, another embodiment of the automated beverage dispensing system 20 employs a linear conveyor 200 in place of the carousel 24 described above. The linear conveyor 200 can be configured to move a plurality of container receivers 30 in a single direction along a substantially straight path from a first end of the linear conveyor 200 to a second end of the linear conveyor 200. The linear conveyor 200 can comprise a belt, a chain, a series of linked platforms, and/or a track along which the container receivers 30 are carried and/or propelled. A motor can be coupled to the linear conveyor 200 and can be controlled by the master controller 110 to selectively advance the container receivers 30 from position to position along the linear conveyor 200.

In the embodiment of FIG. 8, the container dispenser 40 can be disposed adjacent the first end of the linear conveyor 200. The container dispenser 40 can comprise the rotating mount 94 supporting a plurality of hoppers 96, each hopper 96 holding a different size of container 43, as described above. The container dispenser 40 can selectively dispense a container 43 of the appropriate size into an aligned container receiver 30 at the first end of the linear conveyor 200. After the container 43 has been dispensed, the linear conveyor 200 can advance the container receiver 30 forwardly toward the pouring assembly 48.

The pouring assembly 48 can be disposed along the linear conveyor 200 at a position downstream of the container dispenser 40. The pouring assembly 48 can comprise a first pour body 50A and a second pour body 50B, each supported by a pour base 52 and each having a spigot 54 with a control valve 56 connected to a beverage source 60 via a flexible line 62, as described above. The pour bodies 50A and 50B can be spaced apart along the linear conveyor 200 so that each pour body 50 is aligned with a different container receiver 30 position, enabling simultaneous pouring into two containers 43. In other embodiments, one, three, four, or more pour bodies 50 can be arranged along the linear conveyor 200.

The labeling system such as the label printer 100 with the applicator portion 102 can be disposed along the linear conveyor 200 at a position downstream of the pouring assembly 48. The access zone 66 can be defined at and/or adjacent the second end of the linear conveyor 200, downstream of the labeling system. Electronic displays 104 can be arranged adjacent the container receiver positions within the access zone 66, as described above. The master controller 110 can coordinate the operations of the container dispenser 40, the linear conveyor 200, the pouring assembly 48, the labeling system, and/or the electronic displays 104 in the same manner as described above with respect to the carousel 24, with the linear conveyor 200 advancing the container receivers 30 forwardly along the straight path rather than around a closed loop.

In some embodiments employing the linear conveyor 200, empty container receivers 30 that have passed through the access zone 66 and from which filled containers 43 have been removed can be returned to the first end of the linear conveyor 200 via a return path. The return path can be a lower level of the linear conveyor 200, a parallel return conveyor, and/or a manual process in which a worker transfers empty container receivers 30 from the second end to the first end.

In other alternative embodiments, the conveyor can follow a curved, serpentine, and/or multi-segment path rather than a straight path or a closed loop. For example, the conveyor can include one or more turns so as to fit within a defined footprint while still providing a single-direction flow from the container dispenser 40 through the pouring assembly 48 to the access zone 66. The shape and/or layout of the conveyor path can be selected based on the available space, the number of stations to be included along the path, and/or the desired throughput of the system 20. The conveyor may have the conveying surface that carries the containers from the first end to the second end of the conveyor, and once the containers are removed from the conveyer, the conveyor may make a turn in a vertical direction, such that a return path of the conveyor is below the container conveying path.

Although the embodiments described above have been discussed primarily in the context of beer, the automated beverage dispensing system 20 can be configured to pour any of a variety of beverages. For example, the beverage sources 60 can include kegs, tanks, bottles, and/or other vessels containing wine, hard cider, hard seltzer, kombucha, cold brew coffee, nitro coffee, cocktails, non-alcoholic beer, soda, and/or any other beverage that can be dispensed through a spigot 54 under pressure and/or by gravity. Different beverages can have different pour characteristics, and the database 116 can store pour procedures tailored to each type of beverage. For example, a pour procedure for wine can specify a different spigot depth profile, flow rate, and/or total pour volume than a pour procedure for beer. A pour procedure for nitro coffee can account for the nitrogenation of the beverage and can specify a head-generation phase that produces a characteristic creamy foam layer. A pour procedure for a cocktail can account for the viscosity and/or carbonation level of the mixed beverage. As such, the automated beverage dispensing system 20 can serve as a versatile dispensing platform for a wide range of beverages in a variety of venue types including restaurants, bars, sports arenas, concert venues, convention centers, cafeterias, and/or catering events.

In some embodiments, the pouring assembly 48 can be configured to dispense more than one beverage into the same container 43 during a single pour cycle so as to create a blended and/or layered beverage. For example, a first pour body 50A can pour a first beverage into the container 43, and a second pour body 50B can pour a second beverage into the same container 43 after the carousel 24 and/or the linear conveyor 200 advances the container 43 from the first pour body 50A to the second pour body 50B. The master controller 110 can direct each pour body 50 to pour a specified volume of the respective beverage according to a recipe stored in the database 116. In some embodiments, the recipe can specify the order in which the beverages are poured, the volume of each beverage, and/or whether the beverages are to be layered (poured at different spigot depths so as to maintain separation) and/or mixed (poured at similar spigot depths so as to promote blending). As such, the automated beverage dispensing system 20 can create custom blended and/or layered beverages automatically.

Although the embodiments described above have been discussed primarily in the context of plastic cups, the containers 43 can include any suitable type of beverage container. For example, the containers 43 can be paper cups, biodegradable cups, glass cups, glass pints, aluminum cups, reusable plastic cups, branded souvenir cups, growlers, pitchers, and/or aluminum cans. In embodiments employing reusable containers 43, the container dispenser 40 can be loaded with clean reusable containers 43, and/or customers can present their own reusable containers 43 to a worker who places the reusable container 43 into a container receiver 30 manually.

In some embodiments, the automated beverage dispensing system 20 can include a lid application station disposed along the path of the container receivers 30 at a position downstream of the pouring assembly 48 and/or downstream of the labeling system. The lid application station can be configured to apply a lid to the filled container 43 as the container receiver 30 passes the lid application station. The lid application station can include a lid dispenser that holds a stack of lids and a lid applicator that picks a lid from the stack and presses the lid onto the top of the filled container 43. The master controller 110 can direct the lid application station to apply a lid sized to correspond to the size of the container 43 in the container receiver 30. In some embodiments, the lid application station can include a plurality of lid dispensers each holding a different size of lid, and the master controller 110 can select the appropriate lid dispenser based on the detected and/or expected container size. In other embodiments, a single size of lid can be compatible with all sizes of containers 43 if the containers 43 share a common open top diameter.

In some embodiments, the automated beverage dispensing system 20 can include an ice dispensing station disposed along the path of the container receivers 30 at a position upstream of the pouring assembly 48 and downstream of the container dispenser 40. The ice dispensing station can be configured to dispense a measured quantity of ice into the container 43 before the beverage is poured. The master controller 110 can direct the ice dispensing station to dispense a quantity of ice corresponding to the container size and/or to a customer preference specified in the order. The ice dispensing station can include an ice hopper, a metering mechanism such as an auger and/or a gate, and/or a chute configured to direct ice into the container 43 in the aligned container receiver 30. In embodiments in which the beverage is beer and/or another beverage that is not typically served with ice, the ice dispensing station can be bypassed and/or deactivated by the master controller 110.

In some embodiments, the automated beverage dispensing system 20 can include a garnish station disposed along the path of the container receivers 30 at a position downstream of the pouring assembly 48. The garnish station can be configured to apply a garnish to the filled container 43, such as a citrus slice, a cocktail umbrella, a straw, and/or any other suitable garnish and/or accessory. The garnish station can include one or more dispensers each holding a different type of garnish, and the master controller 110 can direct the appropriate dispenser to apply the garnish specified in the order.

In some embodiments, the automated beverage dispensing system 20 can be housed within an enclosure. The enclosure can be a countertop unit configured to sit on a table and/or a counter, a built-in unit configured to be installed within a bar and/or a counter, a freestanding kiosk configured to be placed on a floor, and/or a mobile cart configured to be moved to different locations within a venue. The enclosure can include panels, doors, and/or windows that provide access to the interior components of the system 20 for loading containers 43 into the hoppers 96, connecting and/or replacing beverage sources 60, performing maintenance, and/or clearing error conditions. In some embodiments, the enclosure can include a transparent window and/or a transparent panel through which customers and/or workers can observe the operation of the system 20. In some embodiments, the enclosure can include an integrated refrigeration compartment configured to hold one or more beverage sources 60 at a desired storage temperature.

In some embodiments, the automated beverage dispensing system 20 can be configured as a modular system in which individual stations can be added, removed, and/or rearranged along the carousel 24 and/or the linear conveyor 200. For example, a base configuration of the system 20 can include the container dispenser 40, a single pour body 50, and the access zone 66. Additional modules such as additional pour bodies 50, the labeling system, the ice dispensing station, the garnish station, the lid application station, and/or the container rinsing station can be added to the system 20 as desired by coupling the additional modules to the carousel 24 and/or the linear conveyor 200 and communicatively coupling the additional modules to the master controller 110. The modular configuration can enable venue operators to customize the system 20 to their specific needs and/or to expand the capabilities of the system 20 over time.

In some embodiments, the carousel 24 can be driven by a stepper motor that provides precise incremental rotation of the carousel 24 from one position to the next. In other embodiments, the carousel 24 can be driven by a servo motor with a rotary encoder that provides continuous position feedback to the master controller 110. In still other embodiments, the carousel 24 can be driven by a Geneva drive mechanism that converts continuous rotation of a drive wheel into intermittent rotation of the carousel 24, providing a mechanical means of indexing the carousel 24 from one position to the next with a dwell period at each position. In embodiments employing the linear conveyor 200, the linear conveyor 200 can be driven by a stepper motor, a servo motor, and/or a variable-frequency drive coupled to a belt and/or chain drive mechanism. The master controller 110 can control the drive mechanism to advance the container receivers 30 in discrete increments corresponding to the spacing between positions, and/or to advance the container receivers 30 continuously at a controlled speed.

In some embodiments, the automated beverage dispensing system 20 can include a cleaning-in-place system configured to flush the interior of the flexible lines 62, the spigots 54, and/or the control valves 56 with a cleaning solution and/or a sanitizing solution. The cleaning-in-place system can include a reservoir of cleaning solution, a pump, and/or a valve manifold configured to selectively connect the cleaning solution reservoir to one or more of the flexible lines 62 in place of the beverage sources 60. The master controller 110 can direct the cleaning-in-place system to perform a cleaning cycle at scheduled intervals, such as at the end of a business day, at the start of a business day, and/or when a beverage source 60 is changed. During a cleaning cycle, the master controller 110 can open the control valves 56 and direct the pump to circulate the cleaning solution through the flexible lines 62 and the spigots 54 for a defined duration. A rinse cycle with water can follow the cleaning cycle to flush the cleaning solution from the lines before beverage service resumes. The master controller 110 can lock out the pouring assembly 48 from pouring beverages during the cleaning cycle so as to prevent cleaning solution from being dispensed into a container 43.

In some embodiments, a robotic arm can be used in place of and/or in addition to the pour bodies 50 described above. The robotic arm can be mounted adjacent the carousel 24 and/or the linear conveyor 200 and can include an end effector configured to hold a spigot 54 and/or a nozzle. The robotic arm can be configured to move the spigot 54 in multiple axes so as to position the spigot 54 above and/or within a container 43 in any of the container receivers 30 within the reach of the robotic arm. The robotic arm can be a multi-axis articulated arm, a SCARA arm, a delta robot, and/or a Cartesian gantry robot. The master controller 110 can direct the robotic arm to move the spigot 54 to the appropriate container receiver 30, lower the spigot 54 into the container 43, perform the pour according to the selected pour procedure, raise the spigot 54 out of the container 43, and/or move the spigot 54 to a displaced and/or parked position between pours. In some embodiments, the robotic arm can be configured to pick up a filled container 43 from the container receiver 30 and place the filled container 43 on a serving surface and/or hand the filled container 43 to a customer and/or a delivery worker.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above.

What is claimed is:

1. An automated beverage dispensing system, comprising:
a carousel configured to rotate about an axis, the carousel comprising a plurality of container receivers each configured to hold a beverage container;
a container dispenser positioned adjacent the carousel, the container dispenser configured to selectively dispense a beverage container into an aligned one of the container receivers;
a pouring assembly comprising a pour body having a spigot, the spigot including a control valve, the pour body configured to move vertically so as to selectively lower the spigot into the beverage container and raise the spigot out of the beverage container, the spigot configured to be fluidly connected to a beverage source; and
a control system operatively connected to the carousel, container dispenser, and pouring assembly, the control system configured to:
receive a beverage order from a user;
direct the container dispenser to dispense a beverage container into an aligned container receiver;
rotate the carousel to move the beverage container into alignment with the spigot;
direct the pour body to lower the spigot into the beverage container;
direct the control valve of the spigot to dispense a volume of beverage from the beverage source into the beverage container resulting in a filled beverage container; and
rotate the carousel to move the filled beverage container to an access zone for retrieval.

2. The automated beverage dispensing system of claim 1, wherein the container dispenser comprises a plurality of hoppers each configured to hold a different size of beverage container.

3. The automated beverage dispensing system of claim 2, wherein the control system is further configured to:
determine a size of the beverage container dispensed into the aligned container receiver;
compare the determined size to an expected size corresponding to the beverage order; and
direct the spigot to dispense a volume of beverage corresponding to the determined size.

4. The automated beverage dispensing system of claim 1, wherein the pouring assembly comprises a plurality of pour bodies each having a spigot, the spigots being fluidly connected to different beverage sources.

5. The automated beverage dispensing system of claim 4, wherein the spigots of the plurality of pour bodies have different flow characteristics.

6. The automated beverage dispensing system of claim 1, further comprising a labeling system configured to apply a label to the filled beverage container, the label comprising information related to the beverage order.

7. The automated beverage dispensing system of claim 1, further comprising a plurality of displays each associated with one of the container receivers in the access zone, the displays configured to display information related to the beverage order.

8. The automated beverage dispensing system of claim 1, wherein the control system is further configured to:
access a database of pouring procedures;
select a pouring procedure based on the beverage order; and
direct the spigot to fill the beverage container according to the selected pouring procedure.

9. The automated beverage dispensing system of claim 8, wherein the control system is further configured to select the pouring procedure based on at least one of a beverage type, a beverage temperature, an ambient temperature, a barometric pressure, a carbonation level of the beverage, a customer preference, and a spigot type.

10. The automated beverage dispensing system of claim 8, wherein the pouring procedure comprises a body-fill phase in which the control valve is opened to a first degree and the spigot is positioned at or near a bottom of the beverage container, and a head-generation phase in which the control valve is adjusted to a second degree different from the first degree and/or the spigot is raised to a position at or above a liquid surface within the beverage container so as to generate a foam head on the beverage.

11. The automated beverage dispensing system of claim 8, wherein the pouring procedure defines a spigot withdrawal profile specifying a vertical position of the spigot relative to the beverage container as a function of time and/or as a function of a volume of beverage dispensed, and wherein the control system is configured to direct the pour body to move the spigot in accordance with the spigot withdrawal profile during the pour.

12. The automated beverage dispensing system of claim 8, wherein the control valve is a proportional valve, and wherein the pouring procedure defines a valve opening profile specifying a degree of opening of the proportional valve over a course of the pour, and wherein the control system is configured to adjust the proportional valve during the pour in accordance with the valve opening profile.

13. The automated beverage dispensing system of claim 8, further comprising a fill-level sensor configured to detect a liquid level within the beverage container during the pour, wherein the control system is configured to receive data from the fill-level sensor during the pour and adjust one or more parameters of the pouring procedure in real time based on the detected liquid level.

14. The automated beverage dispensing system of claim 1, further comprising a flow sensor disposed in a flexible line between the beverage source and the spigot, the flow sensor configured to measure a volume of beverage flowing through the flexible line, wherein the control system is configured to close the control valve when the measured volume reaches a target pour volume.

15. The automated beverage dispensing system of claim 1, wherein the pour body is further configured to move the spigot out of alignment with the container receiver after filling the beverage container so as to avoid drips into a subsequently aligned container receiver.

16. The automated beverage dispensing system of claim 1, wherein the control system is configured to receive the beverage order from a remote interface on a personal computing device of a customer, the beverage order including a customer location within a venue, and wherein the control system is configured to direct a labeling system and/or an electronic display to associate the customer location with the filled beverage container.

17. The automated beverage dispensing system of claim 1, wherein the control system is configured to record a volume of beverage dispensed for each pour, calculate an estimated remaining volume of beverage in the beverage source, and generate an alert when the estimated remaining volume falls below a threshold.

18. An automated beverage dispensing system, comprising:
a conveyance system comprising a plurality of container receivers, the conveyance system configured to move the container receivers through a series of successive positions;
a container dispenser configured to selectively dispense a container into an aligned one of the plurality of container receivers;
a pouring assembly comprising a pouring body having a spigot, the pouring body being movable so that the spigot can be lowered into a container held in an aligned one of the container receivers, the spigot having a valve and being configured to be operatively connected to a source of beverage; and
a control system configured to receive an order request and direct operation of the conveyance system, the container dispenser and the pouring assembly so as to fill a container with a beverage from the source of beverage, including directing the pouring body to raise the spigot within the container during dispensing of the beverage, and deliver the container to an access zone.

19. The automated beverage dispensing system of claim 18, wherein the control system is configured to access a database of pouring procedures, select a pouring procedure based on an identity of the beverage, and direct the pouring body to execute the selected pouring procedure, the selected pouring procedure comprising directing the pouring body to raise the spigot within the container during dispensing of the beverage so as to control foam generation within the container.

20. The automated beverage dispensing system of claim 18, wherein the conveyance system comprises a linear conveyor configured to move the plurality of container receivers in a single direction along a substantially straight path from a first end of the linear conveyor adjacent the container dispenser to a second end of the linear conveyor at the access zone.
